(19) United States
(12) Patent Application Publication
(10) Pub. No.: US 2015/0095132 A1
(43) Pub. Date: Apr. 2, 2015

(54) SYSTEMS AND METHODS FOR ADMINISTERING INVESTMENT PORTFOLIOS BASED ON INFORMATION CONSUMPTION

(71) Applicants: Lauren VAN HEERDEN, Bedford, NH (US); Michael E. GLOBE, Toronto (CA); Mazin AL-SAMADI, Burlington (CA); Gunalan NADARAJAH, Milton (CA); Orin DEL VECCHIO, Richmond Hill (CA); Michael D. CUMMINGS, Pickering (CA); Prabaharan SIVASHANMUGAM, Farmington Hills, MI (US); Edward LOUNSBURY, Toronto (CA); Paul Mon-Wah CHAN, Markham (CA); Jonathan K. BARNETT, Oakville (CA); Ashraf METWALI, Toronto (CA); Jakub DANIELAK, Toronto (CA)

(72) Inventors: Lauren VAN HEERDEN, Bedford, NH (US); Michael E. GLOBE, Toronto (CA); Mazin AL-SAMADI, Burlington (CA); Gunalan NADARAJAH, Milton (CA); Orin DEL VECCHIO, Richmond Hill (CA); Michael D. CUMMINGS, Pickering (CA); Prabaharan SIVASHANMUGAM, Farmington Hills, MI (US); Edward LOUNSBURY, Toronto (CA); Paul Mon-Wah CHAN, Markham (CA); Jonathan K. BARNETT, Oakville (CA); Ashraf METWALI, Toronto (CA); Jakub DANIELAK, Toronto (CA)

(73) Assignee: The Toronto-Dominion Bank, MIssissauga (CA)

(21) Appl. No.: 14/502,407

(22) Filed: Sep. 30, 2014

Related U.S. Application Data
(60) Provisional application No. 61/884,745, filed on Sep. 30, 2013.
(60) Provisional application No. 62/019,267, filed on Jun. 30, 2014.

(51) Int. Cl. G06Q 40/06; G06Q 30/02

(52) U.S. Cl. CPC G06Q 40/06; G06Q 30/0232; G06Q 40/08
USPC 705/14.32

(57) ABSTRACT

The disclosed embodiments include systems and methods for administering actual and virtual investment portfolios based on social media activities associated with and information consumed by one or more users. The disclosed embodiments may be configured to obtain digital activity data identifying an interaction between the user and one or more social networks, and further, one or more elements of electronic content accessed by the user. The disclosed embodiments may also be configured to identify a loyalty program associated with the user, and a geographic region associated with the user. The disclosed embodiments may also be configured to identify one or more first securities based on the digital activity data, an investment risk tolerance of the user, and at least one or the loyalty program or the geographic region, and to transmit information identifying a first set of the one or more first securities to a user device.

This application claims the benefit of priority to U.S. Provisional Patent Application No. 62/019,267, filed Jun. 30, 2014, and to U.S. Provisional Patent Application No. 61/884,745, filed Sep. 30, 2013, the entire disclosures of which are expressly incorporated herein by reference to their entireties.

### BACKGROUND

1. Technical Field

The disclosed embodiments generally relate to computerized systems and methods for administering investment portfolios in a network environment, such as the Internet. More particularly, and without limitation, the disclosed embodiments relate to computerized systems and methods that create or modify actual and virtual investment portfolios based on a user's consumption of information.

2. Background Information

New investors are often discouraged by the limited level of interaction and engagement available through websites and other investment tools provided by the financial institutions when compared to their social media interactions. While the discouragement may result from a general lack of interest in investing, real or perceived barriers can prevent these new investors from fully understanding the composition of their investment portfolio and the various investment opportunities provided by their financial institutions.

In many instances, the barriers result from a new investor's inability to connect a daily actions and decisions with a performance of a security held within his or her investment portfolio. For example, an investor may “follow” information posted by various business entities within a social network and may thus be interested in these companies, but may be unaware that his or her investment portfolio includes stock of in one or more of these companies or be unaware of how this company aligns to their investment portfolio. The complex nature of financial instruments commonly held in investment portfolios (e.g., mutual funds and exchange-traded funds (ETFs)) further complicates the linkage between the investor's everyday activities, their investment decisions and the performance of his or her investment portfolio. Moreover, even assuming the investor could appreciate the impact of everyday actions on an investment portfolio, the investor would be challenged to monitor this impact over time due to the constantly changing composition of the investment portfolio and to changes in the corporate structure of manufacturers of consumer products.

### SUMMARY

The disclosed embodiments include computerized methods and systems for administering, creating, or modifying actual and virtual investment portfolios based on a user's interaction with one or more social networks and/or the user's consumption of electronic content.

The disclosed embodiments include, for example, a system including a storage device and at least one processor coupled to the storage device. The storage device may store software instructions for controlling the at least one processor when executed by the at least one processor. In one embodiment, the at least one processor may be operative with the software instructions and may be configured to obtain an investment risk tolerance of a user, obtain digital activity data associated with the user, and obtain program data identifying a first loyalty program associated with the user. In some aspects, the digital activity data may include at least one of (i) first data indicative of an interaction between the user and a social network or (ii) second data indicative of elements of electronic content accessed by the user, and the user may be a participant in the first loyalty program. The at least one processor may be further configured to identify a plurality of first securities based on the digital activity data, the first loyalty program, and the investment risk tolerance, and generate one or more electronic commands to transmit information identifying a first set of the first securities to a device of the first user.

The disclosed embodiments also include a computer-implemented method that includes obtaining, by one or more processors, an investment risk tolerance of a user, obtaining, by the one or more processors, digital activity data associated with the user, and obtaining, by the one or more processors, program data identifying a first loyalty program associated with the user. In some aspects, the digital activity data may include at least one of (i) first data indicative of an interaction between the user and a social network or (ii) second data indicative of elements of electronic content accessed by the user, and the user may be a participant in the first loyalty program. The method also includes identifying, by the one or more processors, a plurality of first securities based on the digital activity data, the first loyalty program, and the investment risk tolerance. Further, the method generates, by the one or more processors, an electronic command to transmit information identifying a first set of the first securities to a device of the first user.

Additionally, the disclosed embodiments include a system including a storage device and at least one processor coupled to the storage device. The storage device may store software instructions for controlling the at least one processor when executed by the at least one processor. In one embodiment, the at least one processor may be operative with the software instructions and may be configured to obtain an investment risk tolerance of a user and obtain digital activity data associated with the user. In some aspects, the digital activity data may include at least one of (i) first data indicative of an interaction between the user and a social network or (ii) second data indicative of elements of electronic content accessed by the user. The at least one processor may be further configured to, based on the digital activity data, determine geographic data may specify a geographic region associated with at least one the first or second data. The at least one processor may be further configured to identify a plurality of first securities based on the digital activity data, the geographic region, and the investment risk tolerance, and generate an electronic instruction to transmit information identifying a first set of the first securities to a device of the first user.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIG. 2 is a flowchart of an exemplary method for administering actual and virtual investment portfolios, consistent with disclosed embodiments.

FIGS. 3A and 3B are flowcharts of additional exemplary methods for administering actual and virtual investment portfolios, consistent with disclosed embodiments.

FIG. 4 is a flowchart of another exemplary method for administering actual and virtual investment portfolios, consistent with disclosed embodiments.

FIGS. 5A-5B, 6A-6B, and 7A-7B illustrate exemplary graphical user interfaces, consistent with disclosed embodiments.

### DESCRIPTION OF THE EMBODIMENTS

Reference will now be made in detail to disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, any section headings used herein are for organizational purposes only, and are not to be construed as limiting the subject matter described.

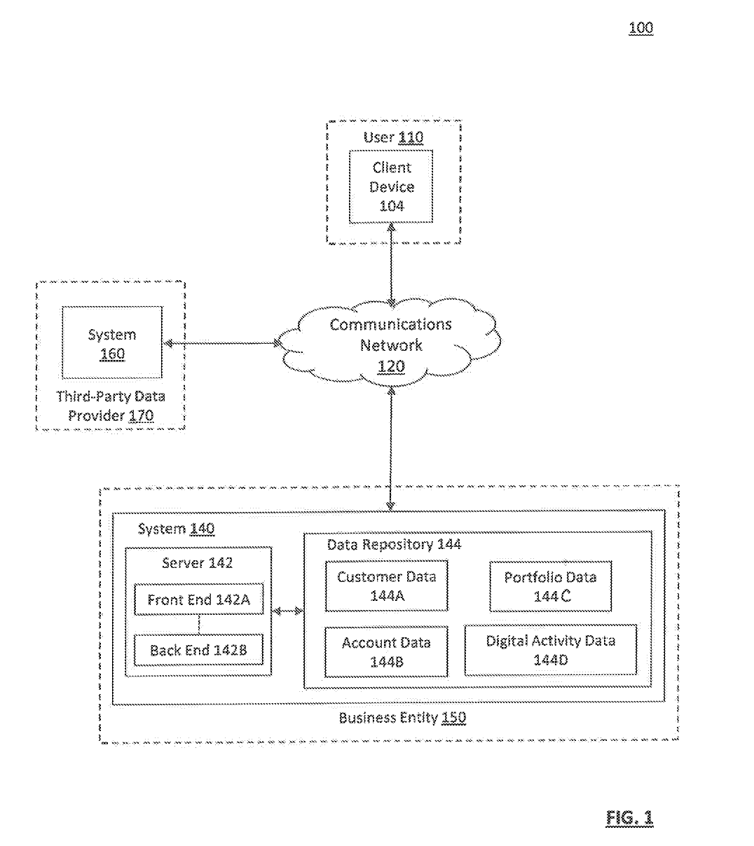

FIG. 1 illustrates an exemplary computing environment 100 consistent with certain disclosed embodiments. In one aspect, computing environment 100 may include a client device 104, systems 140 and 160, and a communications network 120 interconnecting one or more of the components of environment 100.

In one embodiment, client device 104 may be a computing device, such as, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on a display device(s), consistent with disclosed embodiments. In certain embodiments, client device 104 may be associated with one or more users, such as user 110. For instance, user 110 may operate client device 104 and may do so to cause client device 104 to perform one or more operations consistent with the disclosed embodiments.

Client device 104 may include known computing device components. For instance, client device 104 may include one or more tangible, non-transitory memories that store data and/or software instructions, and one or more processors configured to execute software instructions. Client device 104 may include one or more display devices that display information to a user and one or more input device(s) to allow the user to input information to client device 104 (e.g., keypad, keyboard, touch screen, voice activated control technologies, or any other type of known input device).

In one aspect, client device 104 may store in memory one or more software applications that run on client device 104 and are executed by the one or more processors. For instance, client device 104 may store software applications that, when executed by one or more processors, perform operations that allow user 110 (through client device 104) to interact with business entity 150, through, for example, a computing device, such as server 142 or other computing component(s) of system 140. In certain aspects, additional software application may, when executed by client device 104, cause client device 104 to send information to be stored in a memory remote to client device 104 and/or receive information stored in a memory remote to client device 104 (e.g., memory associated with server 142, such as data repository 144). The disclosed embodiments are, however, not limited to such exemplary configurations, and in further embodiments, client device 104 may be configured in any additional or alternate manner to enable communication and data exchange with systems 140 and 160 across network 120.

Business entity 150 may, for example, be any type of business entity that may provide financial account(s) to one or more users (e.g., customers of business entity 150). For example, business entity 150 may be a financial institution, such as a commercial bank, an investment bank, a provider of a payment instrument or financial service accounts, etc. In some embodiments, a financial service account may be a check, savings, credit, debit, prepay account, and/or a reward or loyalty account, and a payment instrument may include, but is not limited to, a personal or corporate credit card, a debit card, a prepaid credit or debit card, or a check instrument. Further, in certain aspects, user 110 may be a customer or a potential customer of business entity 150. In other aspects, user 110 may be a customer that holds one or more financial accounts with business entity 150, such as a checking account, savings accounts, credit card account, debit accounts, line of credit accounts, and/or other types of accounts.

System 140 may be a computing system configured to execute software instructions to perform one or more operations consistent with disclosed embodiments. In one aspect, system 140 may be associated with business entity 150, e.g., a financial institution. System 140 may be a distributed system that may include computing components that are distributed across one or more networks, such as network 120, or other networks.

In one aspect, system 140 may include computing components known to those skilled in the art and configured to store, maintain, and generate data and software instructions. For example, system 140 may include one or more servers (e.g., server 142) and one or more tangible, non-transitory memory devices (e.g., storing database 144). Server 142 may include one or more computing devices (e.g., servers) that may be configured to execute software instructions to perform one or more processes consistent with the disclosed embodiments. In one example, server 142 may be a computing device that executes software instructions that perform operations that provides information to one or more other components of computing environment 100. In one embodiment, server 142 may include a general purpose computer (e.g., a personal computer, network computer, server, or mainframe computer) having one or more processors that may be selectively activated or reconfigured by a computer program. In one aspect, server 142 (or other computing components of system 140) may be configured to provide one or more websites, digital portals, etc., that provide services consistent with business entity 150, such as an digital banking portal, and services consistent with disclosed embodiments. For instance, server 142 may be configured to provide information associated with a requested web page over communications network 120 to client device 102, which may render the received information and present content from the web page on a display device. Additionally, server 142 may be incorporated as a corresponding node in a distributed network, and additionally or alternatively, as a corresponding networked server in a cloud-computing environment. Furthermore, server 142 may communicate via network 120 with one or more additional servers (not shown), which may facilitate the distribution of processes for parallel execution by the additional servers.

In other aspects, system 140 may also be configured to initiate and execute one or more financial services transactions, which include, but are not limited to, a purchase or sale of goods or services, a transfer of funds between financial accounts (e.g., checking, savings, investment, etc.), a payment of a bill, a purchase or sale of a financial instrument or security, a deposit or withdrawal of funds, or an application for credit. In one embodiment, client device 104 may exchange information and parameters facilitating execution of one or more transactions associated with system 140 (e.g., through one or more websites and/or digital portals presented by client device 104).

Data repository 144 may include one or more memories that are configured to store and provide access to data and/or software instructions. Such memories may include tangible non-transitory computer-readable media that store software instructions that, when executed by one or more processors (e.g., of server 132), perform operations consistent with disclosed embodiments. Data repository 144 may also be configured to store information relating to business entity 150. In certain aspects, data repository 144 may be configured to store data identifying customers of business entity 150 (e.g., customer data 144A), financial account data associated with the customers (e.g., account data 144B), investment portfolio data associated with the customers (e.g., portfolio data 144C), and data indicative of current and past digital activities of the customers (e.g., digital activity data 144D)

In one aspect, customer data 144A may include data records that uniquely identify users of a financial institution associated with system 140. By way of example, a customer of the financial institution (e.g., user 110) may access a web page associated with system 140 (e.g., through a web server executed by front end 142A), and may register for digital banking services and provide data, which may be linked to user 110 and stored within customer data 144A. Customer data 144A may, for example, include personal information (e.g., a user name, a home address, and a date of birth), government-issued identifiers (e.g., driver's license numbers and Social Security numbers), employment information (e.g., employer name and address), and contact information (e.g., email addresses, home numbers, work numbers, and mobile numbers). In some instances, customer data 144A may also include information identifying specific interests of user 110 (e.g., health and fitness, renewable energy and “green” technologies, etc.). Customer data 144A may also include authentication credentials associated with registered users of the financial institution. For example, the authentication credentials for user 110 may include, but are not limited to, a user name, a user-specified password, a system-generated password, or an alphanumeric identification number (e.g., a PIN number) specified by user 110 or assigned by financial system 140. Other types of user information may be stored and used by the disclosed embodiments.

Additionally or alternatively, customer data 144A may include information facilitating enhanced authentication techniques. For example, customer data 144A may store information identifying a security question associated with user 110 (e.g., “What is your mother's maiden name?”) and user 110's registered answer to that security question. Customer data 144A may also include information identifying a particular security image or avatar selected by user 110 and displayed by user 110 during the authentication process.

Further, in an embodiment, customer data 144A may include user device identification information that identifies one or more devices registered to user 110. In one embodiment, user 110 may provide user 110 device identification information (e.g., a mobile telephone number provided by user 110 when registering for digital banking services), or alternatively, system 140 may be configured to execute processes that automatically collect user device identification information (e.g., collecting an Internet Protocol (IP) address associated with user 110's smartphone).

In certain aspects, account data 144B may include account identification information identifying one or more accounts of users of the financial institution associated with system 140. In one embodiment, account identification information may include information associated with a financial service account, such as, for example, a checking account, a savings account, a revolving credit line, an account linked to a credit or debit card, a brokerage account, and any additional or alternate account provided or supported by the financial institution. In some embodiments, information within account data 144B may identify one or more accounts associated with user 110 and account data corresponding to the accounts (e.g., an account number, expiration date information, card security codes, account balance information, and/or credit limit information).

Further, in additional embodiments, the user may participate in a loyalty program provided by the financial institution, and additionally or alternatively, by one or more physical or electronic retailers (e.g., a retailer associated with merchant system 150). In some aspects, loyalty programs consistent with the disclosed embodiments may include rewards programs, such as those rewards programs that accrue points for participating users. For example, user 110 may regularly stay in Marriott™ hotels during business travel, and user 110 may enroll in a rewards program sponsored by Marriott™ to obtain rewards points that user 110 may exchange for discounted hotel rates, upgrades, and other benefits. In some aspects, account data 144B may include identification information identifying the one or more loyalty or rewards programs in which user 110 participates, account information associated with the one or more rewards programs (e.g., account numbers, account holders, addresses, etc.), and further, information identifying user 110's current balance of rewards or loyalty points.

Portfolio data 144C may include information identifying investment portfolios held by users of the financial institution. In one aspect, portfolio data 144C may include information identifying a real or “actual” investment portfolio composed of actual financial positions held by a user in various securities. In further aspects, portfolio data 144C may include information identifying one or more “virtual” investment portfolios composed of “simulated” positions held by user 110 in various securities. In some aspects, the “virtual” investment portfolios may include one or more “watch lists” that specify various securities monitored by user 110 and corresponding simulated positions held by user 110 in these various securities.

In certain embodiments, the securities associated with user 110's actual investment portfolio, virtual investment portfolio, and watch list may represent various equity and debt securities, including, but not limited to, shares of common stock, corporate or governmental bonds, mutual funds, bond funds, etc. Further, portfolio data 144C may include information identifying the simulated or actual positions held by user 110 in these securities, as well as information identifying a schedule for providing electronic updates to user 110 regarding a performance of these securities (e.g., daily, weekly, monthly, quarterly, or in response to customer-specific events).

In some aspects, portfolio data 144C may also include information identifying issuers of one or more of the equity and debt securities associated with and/or available for inclusion within the user's actual investment portfolio, virtual investment portfolio, and watch list. For example, portfolio data 144C may identify a corporate or other business entity that issues a common stock available for inclusion in user 110's actual investment portfolio, virtual investment portfolio, and watch list, and further, a corporate, business, or other municipal entity that issues a debt security available for inclusion in user 110's actual investment portfolio, virtual investment portfolio, or watch list.

In other aspects, portfolio data 144C may include information identifying one or more investment programs or offers available to user 110. For example, portfolio data 144C may identify one or more dividend reinvestment plans (DRIPs) offered by issuers of common stock held or available for inclusion within user 110's actual investment portfolio, virtual investment portfolio, or watch list. Further, in some instances, portfolio data 144C may also identify one or more initial public offerings (IPOs) of common stock that are available for inclusion into user 110's actual investment portfolio. The disclosed embodiments are, however, not limited to such exemplary issuers, investment programs, and offers, and in further embodiments, portfolio data 144C may include any additional or alternate information identifying securities, investment programs, and/or investment offerings held by user 110 or available for inclusion in user 110's actual investment portfolio, virtual investment portfolio, or watch list.

Portfolio data 144C may also include information identifying an investment risk tolerance of user 110. In one embodiment, user 110's investment risk tolerance may represent a score ranging from one, which indicates a completely risk-averse user, to ten, which indicates a user willing to accept significant speculative risk within a corresponding actual or virtual investment portfolio. By way of the example, the investment risk tolerance score may be specified by user 110, e.g., at an initial registration to access investment products associated with the financial institution, or alternatively, may be determined by system 140 from an outcome of an interactive financial investment game, as outlined below.

Further, portfolio data 144C may include information identifying one or more investment goals of user 110. Investment goals consistent with the disclosed embodiments include, but are not limited to, a specified cash reserve associated with an actual or virtual investment portfolio, a maximum value of all securities and cash within an actual or virtual investment portfolio, and a ratio of debt instruments (e.g., bonds) to equity instruments (e.g., common stock) within an actual or virtual investment portfolio.

In certain embodiments, financial system 140 may be configured to execute software processes that provide an digital banking portal enabling user 110 to generate and administer a virtual investment portfolio and/or watch list that includes one or more securities of interest (e.g., identified based on user 110's prior and/or current consumption of information). Financial system 140 may, in such embodiments, be configured to store information identifying the generated virtual investment portfolio and/or watch list within portfolio data 144C. In certain aspects, the information obtained through user 110's interaction with the virtual portfolio or the watch list may provide user 110 with sufficient confidence generate and administer an actual investment portfolio composed of actual positions in the securities of interest.

In further embodiments, the digital banking portal allows user 110 to “rebalance” a virtual or actual investment portfolio by increasing or decreasing a position in one or more securities (e.g., an equity position in an equity security and a creditor position in a debt security). For instance, the rebalancing of the virtual or actual investment portfolio may occur at periodic intervals, in response to certain events within the marketplace (e.g., in response to market fluctuations of predetermined magnitude), or alternatively, in response to one or more transactions to purchase goods or services. Further, in some embodiments, a financial advisor or third party associated with the financial institution may advise user 110 regarding the rebalancing of the actual or virtual portfolio.

Portfolio data 144C may further identify one or more securities that are offered for sale by or through the financial institution associated system 140. In certain aspects, these securities may be “available” for incorporation into an actual or virtual investment portfolio of user 110, and further, into a watch list maintained by system 140 for user 110.

Digital activity data 144D may include information indicative of an interaction of customers of the financial institution with one or more social networks (e.g., (e.g., Facebook™, Twitter™, FourSquare™, and/or LinkedIn™), and additionally of alternatively, information indicative of electronic content consumed by the customers. By way of example, digital activity data 144D may include information indicative of an interaction of a (e.g., user 110) with one or more social networks during a pre-determined or user-specified prior time period. Further, in some aspects, digital activity data 144D may also include information indicative of user 110's current interaction with the one or more social networks.

For example, digital activity data 144D may identify one or more individuals, products, services, and/or business entities directly connected to user 110 within a social network (e.g., without intermediate users) and/or indirectly connected to user 110 within the social network (e.g., through one or more intermediate users). Digital activity data 144D may also identify one or more social media feeds to which user 110 subscribes. In other aspects, digital activity data 144D may include information posted by user 110 to one or more social networks, information tagged by user 110 within the one or more social networks, comments provided by user 110 on previously posted information, and any additional or alternate information indicative of user 110's current or prior social networking activities.

In some embodiments, digital activity data 144D may identify one or more elements of electronic content currently accessed and viewed (e.g., “consumed”) by user 110, and additionally or alternatively, one or more elements of electronic media consumed by user 110 during a predetermined or user-specified prior time period. In certain aspects, digital activity data 144D may identify a web page or other web-accessible electronic document currently and/or previously viewed by user 110. For example, digital activity data 144D may include a Uniform Resource Locator (URL) associated with the identified web page, as well as information (e.g., text, metadata, and/or and HTML code) identifying portions of web page content consumed by user 110 through client device 104. Digital activity data 144D may also identify and characterize contents of one or more news feeds to which user 110 subscribes. The disclosed embodiments are, however, not limited to web pages and news feeds, and in additional embodiments, digital activity data 144D may identify and characterize any additional or alternate element of electronic content previously or current consumed by user 110, including, but not limited to, an electronic book, digital video content, and digital audio content.

In other aspects, digital activity data 144D may also identify and characterize one or more web-based activities currently or previously performed by user 110. For example, digital activity data 144D may indicate that user 110 visited a website associated with an electronic retailer on a particular time and date. In some instances, digital activity data 144D may identify content associated with one or more products and services that user 110 viewed when browsing the electronic retailer's web site, and further, one or more products and services purchased by user 110 through the web site of the electronic retailer.

In some aspects, system 140 may obtain portions of digital activity data 144D from an external data provider (e.g., system 160 of third-party data provider 170 described below), which may include, but is not limited to, one or more social media aggregation services, search engines, content providers, and other services capable of tracking and aggregating digital activity associated with multiple users. By way of example, system 140 may receive data from the external data provider a predetermined regular intervals or at adaptively determined intervals (e.g., based on the digital activity of user 110). Further, in other aspects, system 140 may obtain portions of digital activity data 144B from client device 104, which may be configured to monitor digital activities of user 110, and transmit information indicative of the monitored social media and digital activities to system 140 at periodic or regular intervals, or in response to predetermined events (e.g., then client device 104 enters a “standby” mode or is powered off by user 110).

System 160 may be one or more servers or computer systems configured to process and store information, and execute software instructions to perform one or more processes consistent with the disclosed embodiments. In certain exemplary embodiments, although not required, system 160 may be associated with a third-party data provider 170. By way of example, third-party data provider 170 may include, but is not limited to, a social media aggregator (e.g., an entity that aggregates, compiles, and provides social media consumption data to third parties), a social media provider (e.g., an entity that provides social media sites), a search engine, a content provider, a system associated with an Internet service provider (ISP), and any additional or alternate entity capable of obtaining, storing, and/or providing content consumption data associated with one or more users.

Although computing environment 100 is illustrated in FIG. 1 with client device 104 in communication with system 140, persons of ordinary skill in the art will recognize that environment 100 may include any number of number of mobile or stationary client devices 104, and any additional number of computers, systems, or servers without departing from the spirit or scope of the disclosed embodiments. Further, although computing environment 100 is illustrated in FIG. 1 with a single business entity 150 and/or system 140, persons of ordinary skill in the art will recognize that environment 100 may include any number of additional number of business entities and corresponding systems, any number of additional number of servers and data repositories, and any additional number of computers, systems, servers, or server farms without departing from the spirit or scope of the disclosed embodiments.

Communications network 120 may include one or more communication networks or medium of digital data communication. Examples of communication network 120 include a local area network (“LAN”), a wireless LAN, a RF network, a Near Field Communication (NFC) network, (e.g., a “WiFi” network), a wireless Metropolitan Area Network (MAN) connecting multiple wireless LANs, NFC communication link(s), and a wide area network (“WAN”), e.g., the Internet. Consistent with embodiments of the present disclosure, communications network 120 may include the Internet and any publicly accessible network or networks interconnected via one or more communication protocols, including, but not limited to, hypertext transfer protocol (HTTP) and transmission control protocol/internet protocol (TCP/IP). Communications protocols consistent with the disclosed embodiments also include protocols facilitating data transfer using radio frequency identification (RFID) communications and/or NFC. Moreover, communications network 120 may also include one or more mobile device networks, such as a GSM network or a PCS network, allowing client device 104 to send and receive data via applicable communications protocols, including those described herein.

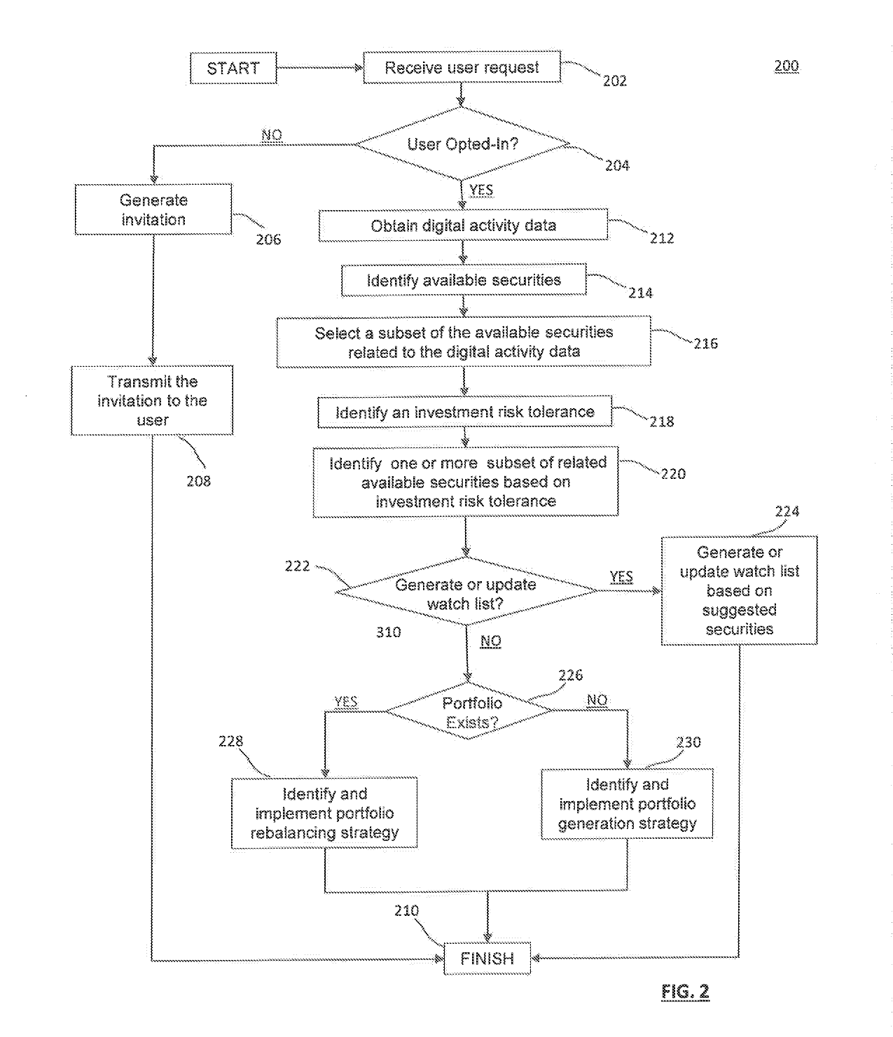

The disclosed embodiments include systems and methods that enable a user (e.g., user 110) to identify securities of interest based on user 110's digital activities, and to generate and administer “virtual” and “actual” investment portfolios based on these identified securities. For example, as described below in reference to FIG. 2, user 110 may, through client device 104, access a digital portal associated with a system of a financial institution (e.g., system 140). The digital portal may include a web page associated with the financial institution and presented by client device 104. In other aspects, the digital portal may correspond to a graphical user interface provided by an application executed client device 104, e.g., a mobile “app” provided by the financial institution associated with system 140. In some embodiments, using the digital portal, user 110 may receive information identifying one or more securities (e.g., “suggested” securities) that may be related to user 110's recent digital activities (and additionally or alternatively, recently digital activities of the user's friends and family), and further, that may be consistent with an investment risk tolerance of user 110. In other instances, an investment advisor associated with the financial institution may, at the request of the user, access the online portal and convey, to the user, the information identifying the one or more suggested securities.

In some aspects, one or more of the suggested securities may be relevant to recent activity of user 110 within a social media network (e.g., Facebook™, Twitter™, and/or LinkedIn™), and additionally or alternatively, may be relevant to other individuals or business entities whose activities user 110 monitors within the social media network. By way of example, and as described below, system 140 may access social media consumption data and determine that user 110 recently followed an individual, product, service, or business entity within the social media network. In certain aspects, system 140 may identify one or more securities to user 110 that are relevant to the product, service, and/or business entity (e.g., that are issued by the business entity or a corporate parent of the business entity, or that are issued by a manufacturer, retailer, or supplier associated with the product).

In other aspects, described below, system 140 may monitor a social media stream associated with user 110 (e.g., user 110's “news feed” on Facebook™) and may identify one or more products or business entities of potential interest to user 110 using natural language search techniques, semantic search techniques, and/or character recognition techniques. By way of example, system 140 may determine that user 110 posts information (e.g., text and/or images) to the social network identifying one or more products, services, and business entities. Further, in some instances, system 140 may ascertain an interest of user 110 in a product or business entity based on information posted to the social network and tagged by user 110. In some embodiments, system 140 may identify one or more securities relevant to the product, service, or business entity of interest to user 110, which may be presented to user 110 within the digital portal.

Furthermore, system 140 may identify the one or more suggested securities based not on social media activity of user 110, but based on social media activities of one or more individuals “followed,” “liked,” or otherwise monitored by user 110 within the social network. For example, user 110 may subscribe to a social networking feed of a particular individual within a social network. In some aspects, system 140 may monitor not only the social media activity of user 110, but also the social media activity of the particular individual, and additional individuals “followed,” “liked,” or otherwise monitored by the particular individual within the social network, to identify the one or more suggested securities for presentation to user 110.

The disclosed embodiments are, however, not limited to, processes that identify suggested securities based on the social media activities of user 110. In other embodiments, one or more of the suggested securities may be relevant to various elements of electronic content consumed by user 110, including, but not limited to, information provided to user 110 through various news and RSS feeds to which user 110 subscribes, web pages viewed by user 110, products purchased through corresponding web pages, content presented to user 110 through mobile applications of various content providers (e.g., mobile “apps” provided by a news organization and executed by client device 104), and any additional or alternate electronic content consumed by user 110 and monitored by client device 104 and/or system 140.

In some embodiments, the digital portal (e.g., a web page or other graphical user interface) may present information identifying the suggested securities to user 110, and user 110 may further interact with the digital portal, either alone or at the instigation of the investment advisor, to generate or modify a “virtual” investment portfolio that, for example, may include a “watch list” composed of simulated positions in one or more of the suggested securities (e.g., equity positions in equity securities and creditor positions in debt securities). By interacting with the virtual investment portfolio and/or the watch list, user 110 may explore various investment opportunities offered by the financial institution, and further, may explore the impact of various financial conditions and financial services transactions on the simulated positions held within the virtual investment portfolio and/or watch list.

In certain aspects, the disclosed embodiments may be configured to identify, to user 110, relationships between consumed information (e.g., social media and other electronic content) and corresponding investment portfolios, thus enabling the administration of such investments. Certain aspects of the disclosed embodiments include automated mechanisms that provide, analyze, and modify investment portfolio information that cannot be readily done by a user because, for example, of the continual and complex changes to such portfolios, such as mutual funds, corporate structures, and product associations to corporate entities.

FIG. 2 illustrates an exemplary method 200 for administering actual investment portfolios, virtual investment portfolios, and/or watch lists based on digital activity data, in accordance with disclosed embodiments. In one embodiment, a system associated with a financial institution (e.g., system 140 associated with business entity 150) may be configured to obtain data identifying user 110's consumption of electronic content and/or participation in one or more social networks, and may be further configured to suggest one or more securities (e.g., common stocks, bonds, and/or derivatives contracts) related to the consumed electronic media and/or the social media participation. In certain aspects, system 140 may execute software instructions to incorporate at least a subset of the suggested securities into an investment portfolio held by user 110 (e.g., an “actual” investment portfolio), or alternatively, into a “virtual” investment portfolio or corresponding “watch list” that facilitates user 110's exploration of various investment services of the financial institution.

In other aspects, system 140 may be configured to identify one or more investment strategies that incorporate the subset of suggested securities into the user's investment portfolio in a manner consistent with the user's investment risk tolerance and the user's investment goals. By way of example, system 140 may identify an investment strategy that incorporates, into the user's actual or virtual investment portfolio, particular quantities of the subset of suggested securities that increase an expected rate of return while minimizing a tax burden associated with the incorporation of the securities into the investment portfolio. Further, in some embodiments, system 140 may also be configured to identify and recommend to the user one or more investment programs (e.g., dividend reinvestment programs (DRIPs)) offered by issuers of the suggested securities, and one or more loyalty and/or rewards programs provided by the financial institution or the issuers of the suggested securities. In some aspects, system 140 may provide, to client device 102 for presentation to the user, one or more candidate investment strategies and information identify benefits associated with the candidate investment strategies.

In FIG. 2, in step 202, system 140 may receive a request from client device 104 to access information identifying one or more investment services offered by a financial institution (e.g., business entity 150). For example, user 110 may, via client device 104, access a web page associated with the financial institution that may be presented by client device 104, and may enter one or more authentication credentials (e.g., a user name, a password, an account number, and a personal identification number) into the accessed web page. Client device 104 may generate a request that includes the entered authentication credentials, which client device 104 may transmit to system 140 using one or more of the communications protocols outlined above.

Upon receipt of the request in step 202, system 140 may determine whether user 110 is eligible to access the requested information (e.g., in step 204). By way of example, system 140 may be configured to identify and “suggest” to user 110 one or more securities related to user 110's electronic media consumption and/or social media participation. In certain aspects, system 140 may determine, in step 204, whether user 110 previously granted system 140 permission to access data indicative of user 110's electronic media consumption and/or social media participation (e.g., whether user 110 “opted-in” to receive information identifying the one or more “suggested” securities).

For example, in step 204, system 140 may obtain the authentication credentials from the request, access data associated with user 110 (e.g., within customer data 144A of FIG. 1), and determine whether user 110 previously opted-in to receive information identifying the one or more suggested securities. In some aspects, user 110 may “opt-in” to receive the information by accepting one or more terms and conditions within a web page or other graphical user interface (GUI) presented to user 110 by client device 104. Client device 104 may, for example, transmit information identifying user 110's acceptance of the terms and conditions to system 140, which may store the received information within customer data 144A.

In other aspects, system 140 (and additionally or alternatively, a third-party computer system in communication with system 140 over network 120) may be configured to perform processes that centrally manage user 110's data access rights, user 110's acceptance of terms and conditions of various services provided by the financial institution, and/or user 110's decisions to “opt-in” and participate in the various services. By way of example, system 140 may store information associated with the services to which the user previously opted-in (e.g., within customer data 144A of FIG. 1) and further, may establish parameters that enable system 140 to automatically define user 110's participation in new services (e.g., opt-in by “proxy”). In some aspects, system 140 may, upon receipt of the request to access the investment services, process stored information to determine whether user 110 previously opted-in to receive the requested information, and if not, to determine whether the established parameters indicate the user opted-in by proxy. If system 140 finds user 110 did not “opt-in” and is thus ineligible to receive the requested information (step 204; NO), system 140 may generate a message invites user 100 to “opt-in” to receive the requested information and/or services (e.g., in step 206). In step 208, system 140 may execute software processes to transmit the message to client device 104 over network 120 using one or more of the communications protocols outlined above. Method 200 may then complete in step 210.

If, however, system 140 determines that user 110 opted-in to receive the requested information (step 204; YES), system 140 may obtain data indicative of one or more digital activities of user 110 (e.g., in step 212). By way of example, the digital activity data may include, but is not limited to, social media consumption data indicative of user 110's participation in one or more social networks (e.g., Facebook™, Twitter™, FourSquare™, and/or LinkedIn™), and content consumption data indicative of one or more elements of electronic content (e.g., web pages, news feeds, electronic books, streaming audio and/or video, podcasts, executable mobile applications, etc.) obtained, accessed and/or viewed (e.g., “consumed”) by user 110.

In some aspects, system 140 may obtain the digital activity data from a local data repository (e.g., digital activity data 144D of data repository 144), and additionally or alternatively, from systems associated with one or more external data providers (e.g., system 160 of provider 170). By way of example, external data providers consistent with the disclosed embodiments may include one or more social media aggregation services, search engines, content providers, and other services capable of tracking and aggregating digital activity associated with multiple users. Further, in other aspects, client device 104 may monitor the social media and digital activities of user 110, and may transmit information indicative of the monitored social media and digital activities to system 140 at periodic or regular intervals, or in response to predetermined events (e.g., when client device 104 enters a “standby” mode or is powered off by user 110).

In some embodiments, the digital activity data may include information indicative of a current interaction of user 110 with one or more social networks (e.g., Facebook™, Twitter™, FourSquare™, and/or LinkedIn™), and/or a prior interaction of during a pre-determined or user-specific time period. For example, the digital activity data may list, for user 110, one or more individuals, products, services, and/or business entities with which user 110 is connected within the social network (e.g., user 110's direct connections). For example, the digital activity data may indicate that user 110 subscribes to a social media feed (e.g., a Twitter™ feed) curated by TD Bank™, and may be connected to ten individuals (e.g., as “friends” in Facebook™). Further, for example, digital activity data may indicate that user 110 follows Ben & Jerry's™ ice cream to obtain special offers.

The digital activity data for user 110 may also include information indicative of social media activities of one or more of the individuals with whom user 110 is connected within the social networks. For example, user 110 may be connected directly with “John Smith,” who may follow a social media account associated with Wendy's™ restaurants. By way of example, the digital activity information may indicate an indirect connection between user 110 and Wendy's™ restaurants through a single intermediate user (e.g., John Smith). Further, in some embodiments, the digital activity data for user 110 may include information identifying connections with other users, products, services, and/or business entities through any number of intermediate users.

Additionally, for example, the digital activity data for user 110 may include portions of user 110's social media profile and/or social media profiles of the one or more additional users connected to user 110. In certain aspects, the social media profile data (e.g., from LinkedIn™, etc.) may identify a current employer of user 110 and the connected additional users, as well as one or more prior employers. In some instances, user 110's social media profile may include information identifying specific interests of user 110 (e.g., health and fitness, renewable energy and “green” technologies, etc.).

In other aspects, the digital activity data may identify one or more elements of electronic content currently accessed and viewed by user 110, and additionally or alternatively, accessed and viewed by user 110 during a predetermined or user-specified prior time period (e.g., twelve hours, one day, one week, or one month). For example, the digital activity data may identify a web page previously accessed by user 110, and may include a Uniform Resource Locator (URL) associated with the identified web page, as well as information (e.g., text, metadata, and/or and HTML code) identifying portions of the web page viewed by user 110 through client device 104.

The digital activity data may also include statistics describing how often user 110 access the web sites during the prior time period (e.g., user 110 accessed Amazon.com™ forty-three times over the past month). Further, the digital activity data may also indicate that, during these multiple visits to Amazon.com™, user 110 views streaming video content provided by Universal Pictures™. The disclosed embodiments are, however, not limited to web sites and web pages, and in additional embodiments, digital activity may include information identifying one or more additional elements of media currently accessed by user 110 during the prior time period (e.g., electronic books, digital video content, and digital audio content).

In additional embodiments, the digital activity data may also identify one or more news and/or content streams to which user 110 subscribes. For example, user 110 may subscribe to one or more Rich Site Summary (RSS) feeds provided by news organizations (e.g., CNN™ or Bloomberg.com™), governmental organizations, and other content providers. In certain aspects, the digital activity data may identify the business entities that provide user 110's news feeds (e.g., CNN.com™ or Bloomberg.com™), may further include textual, audible, and/or visual content delivered within the news feeds. Furthermore, the digital activity data may also identify one or more executable mobile applications accessed and downloaded onto client device 104 by user 110. For example, user 110 may, through a corresponding electronic retailer (e.g., an “app” store such as Google Play™), download onto client device 104 mobile apps provided by news providers (e.g., CNN™ and ESPN™), content providers (e.g., Comcast™), or financial institutions (e.g., TD Bank™).

Referring back to FIG. 2, in step 214, system 140 may identify one or more securities available for inclusion in an actual investment portfolio, a virtual investment portfolio, and/or a watch list of user 110. By way of example, system 140 may identify the available securities by accessing and analyzing information stored in one or more data storages (e.g., portfolio data 144C of data repository 144, or external data repositories accessible to system 140 over network 120). System 140 may also be configured to identify (e.g., in step 214), business entities that issue the available securities, and one or more products and/or services provided by the issuing business entities. Further, in some aspects, system 140 may also be configured to identify competing business entities based on information identifying similarities in product types, product sectors, or other parameters.

For example, system 140 may access and analyze stored portfolio data to identify available securities that include common stock issued by the Toronto-Dominion Bank™, which provides financial services as TD Bank™. Further, for example, system 140 may determine that common stock issued by Unilever™, which provides different types of products, such as Ben & Jerry's™ (e.g., ice cream) and Good Humor™ (e.g., ice cream), are available for inclusion in user 110's real or virtual investment portfolio. System 140 may also identify available securities that include common stock issued by competitors of Unilever™, such as General Mills™ which provides competing ice cream products, such as HAagen-Dazs™. Further, for example, system 140 may also identify available common stock issued by TimeWarner™, which is the corporate parent of the CNN™ network and CNN.com™, and Comcast™, which is the corporate parent of Universal Pictures™.

In other aspects, system 140 may access and analyze stored portfolio data to determine that The Wendy's Company™ is the privately held corporate parent of the Wendy's™ restaurants, and further, that securities issued by The Wendy's Company™ are not available for inclusion within an actual or virtual investment portfolio of user 110. Similarly, for example, system 140 may identify Bloomberg LP™ as the privately held corporate parent of Bloomberg.com™, and determine that securities issued by Bloomberg LP™ are not available to user 110.

System 140 may also execute software instructions to identify one or more of the available securities (e.g., “candidate securities”) that are relevant to the digital activity data of user 110, and thus, may be of potential interest to user 110 (e.g., in step 216). In certain aspects, system 140 may determine that an available security is “relevant” to user 110's digital activity when a relationship exists between an issuer of the available security and the social networking activity and/or electronic content consumed by user 110 (and additionally or alternatively, user 110's friends and family). In some embodiments, system 140 may identify the relationship based on a reference to the issuer of the available security, a product provided by the issuer, a competitor of the issuer, and/or a product provided by the competitor within user 110's digital activity data.

By way of example, system 140 may process the digital activity data in step 216 to determine that user 110 subscribes to a social media feed curated by TD Bank™, and follows postings of Ben & Jerry's™ ice cream within a social network. In certain aspects, system 140 may determine a relationship between Unilever™, which issues available common stocks, and user 110's recent social media activity involving Ben & Jerry's™ premium ice cream (which is provided by Unilever™). System 140 may also identify a relationship between a financial institution (e.g., Toronto-Dominion Bank™), which issues available common stock, and user 110's subscription to the social media feed sponsored by the institution. In certain aspects, system 140 may determine that available common stock issued by the financial institution (e.g., the Toronto-Dominion Bank™) and available common stock issued by Unilever™ are relevant to the digital activities of user 110 and thus, may be of potential interest to user 110.

In additional embodiments, system 140 may be configured to identify available securities of potential interest to user 110 based on a relevance of the available securities to elements of electronic content consumed by user 110 (e.g., as indicated within the obtained digital activity data). For example, system 140 may determine that an available security is relevant to user 110's content consumption when a relationship exists between an issuer of the available security and electronic content consumed by user 110. In certain embodiments, system 140 may identify the relationship based on a reference to the issuer of the available security, a product provided by the issuer, a competitor of the issuer, and/or a product provided by the competitor within portions of the digital activity data indicative of user 110's content consumption.

For example, in step 216, system 140 may process the digital activity data and determine that user 110 subscribes to news feeds provided by CNN™ and Bloomberg.com™, and further, that user 110 visited Amazon.com™ forty-three times within the past month. In some aspects, system 140 may determine a relationship between TimeWarner™, which issues available common stocks, and user 110's subscription to a news feed provided by CNN™ (of which TimeWarner™ is the corporate parent). Further, for example, system 140 may also identify a relationship between the Amazon.com™, which issues available common stock, and user 110's digital activity based on user 110's repeated visits to Amazon.com™.

In additional aspects, system 140 may determine a relationship between available securities and elements of electronic content accessed and viewed during visits to Amazon.com™. For example, system 140 may identify a relationship between common stock issued by Comcast™ (e.g., the parent of Universal Pictures™) and the content consumption of user 110 when user 110 streams video content provided by Universal Pictures™ through Amazon.com™ or downloads an Xfinity™ app provided by Comcast™, In some instances, system 140 may determine that common stock issued by Comcast™ may be related to the user 110's prior consumption of digital content, and as such, may be of potential interest to user 110.

In the embodiments described above, system 140 may be configured to identify one or more of the available securities that are relevant to user 110's social media activities and additional or alternatively, user 110's consumption of electronic content, over predetermined or user-specified time periods. For example, system 140 may determine in step 216 that common stock and corporate bonds issued by Unilever™, as well as common stock issued by Toronto-Dominion Bank™, TimeWarner™, Comcast™, Amazon.com™, may be of potential interest to user 110.

In embodiments described above, system 140 may identify available securities of potential interest to user 110 by processing portions of user 110's digital activity data to identify products and/or business entities having relationships with issuers of one or more of the available securities (e.g., in step 216). For example, system 140 may execute software instructions that compare the identified issuers, related business entities (e.g., competitors, subsidiaries, and/or corporate parents), and provided products and services against information within the digital activity data to identify corresponding relationships. In some aspects, system 140 may apply various pre-processing techniques to the digital activity data (e.g., to strip prefixes, suffixes, or other characters from text within the digital activity data) prior to performing the comparative techniques described above. Furthermore, system 140 may also apply one or more natural language and semantic search techniques to portions of user 110's digital activity data to identify the products, services, and/or business entities having relationships with the issuers.

In other aspects, the disclosed embodiments may also be configured to identify one or more securities of potential interest to the user based on location-based data related to user 110, user 110's social media activities, user 110's consumption of electronic content, and/or the social media activities of and electronic content consumed by user 110's friends and family. For instance, in step 216, system 140 may be configured to process the obtained digital activity data and identify direct and/or indirect social-networking connections between user 100 and individuals residing within a particular geographic region, services provided within the particular geographic region, and/or business entities disposed in or operating within the particular geographic region. By way of example, system 140 may determine that user 110 is directly and/or indirectly connected to greater than a threshold number of individuals, services, and business entities associated with Washington, D.C. In some aspects, and based on the threshold number of direct or indirect connections, system 140 may determine that Washington, D.C., represents a geographic region of interest to user 110.

Further, in additional aspects, system 140 may be configured to identify a geographic region of interest to user 110 based on a number of times user 110 identified his or her presence at particular points of interest or business entity within the geographic region (e.g., a number of times user 110 “checked-in” at the particular points of interest using a social networking application executed by client device 104). For example, system 140 may determine that Washington, D.C., represents a geographic region of interest to user 110 when user 110's digital activity data includes greater that a predetermined number of “check-ins” at points of interest within Washington, D.C. Further, in some instances, system 140 may determine that Washington, D.C., is of particular interest to user 110 when user 110 is tagged within images and/or videos captured within or associated with Washington, D.C. (and posted to a social media account of user 110 and/or one or more of user 110's friends).

In further aspects, system 110 may be considered to identify a geographic region of interest to user 110 based on electronic content consumed by user 110. For example, system 140 may establish user 110's interest in Washington, D.C., based on a consumption of electronic content (e.g., web pages, news-feed content, etc.) mentioning Washington, D.C., and additionally or alternatively published by an organization disposed within Washington, D.C. (e.g., a web page or news feed published by the Washington Post™).

Further, in additional aspects, system 140 may establish user 110's interest in Washington, D.C., based on user 110's repeated access of electronic content from devices disposed within Washington, D.C. For example, user 110 may access electronic content and social media networks through an Internet Protocol (IP) address associated with an address in Washington, D.C., and additionally or alternatively, using a mobile communications network that services Washington, D.C. In other instances, transaction server 142 may access profile data associated with the user (e.g., as stored within customer data 144A of FIG. 1), determine a home or other address specified by the user, and establish the geographic region of interested based on the specified address.

In some embodiments, system 140 may identify in step 216 securities whose issuers are relevant to the user's geographic region of interest. For example, as described above, system 140 may determine Washington, D.C., to be the user's geographic region of interest, and may determine that common stock issued by Pepco Holdings, Inc., which is headquartered in Washington, D.C., and which provides electrical power to the Washington, D.C., area, may be of interest to user 110. In other instances, and based on the user's interest in or relationship with Washington, D.C., system 140 determine that municipal bonds issued by the local government of Washington, D.C., are of potential interest to the user in step 216.

The disclosed embodiments may also be configured to identify securities of potential interest to the user based on the user's membership or participation in loyalty programs, such as rewards programs. For instance, in step 216, system 140 may access information identifying one or more loyalty programs associated with the user (e.g., as stored within account data 144B of FIG. 1), and may process the obtained loyalty program information to identify corporate entities associated with the loyalty programs. In some aspects, system 140 may, in step 216, identify securities issued by the corporate entities as being of potential interest to the user based on the user's participation in the corresponding rewards or loyalty programs.

By way of example, system 140 may determine, based on the obtained loyalty program information, that user 110 participates in a Marriott™ rewards program sponsored by the Marriott International, Inc., and may further determine that common stock issued by Marriott International, Inc., is available for inclusion within the user's actual investment portfolio, virtual investment portfolio, and/or watchlists. In certain aspects, system 140 may determine in step 216 that the common stock issued by Marriott International, Inc., may be of potential interest to the user based on the user's participation in the Marriott™ rewards program.

In further embodiments, system 140 may be configured to identify securities of potential user interest in step 216 based on the relationship between an issuer of an available security and the social networking activity and/or electronic content consumed by user 110 (and additionally or alternatively, user 110's friends and family), in combination with the user's participation in one or more loyalty or rewards programs. By way of example, using the exemplary processes described above, transaction server 142 may identify a set of securities issued by entities mentioned within the electronic content consumed by user 110. In some aspects, system 140 may filter the identified set of securities to eliminate those securities whose issues do not sponsor loyalty programs in which the user participates or that are available to user 110.

In other aspects, system 140 may be configured to identify securities available and of potential interest to the user based on information specified by user 110 within user or social media profile data (e.g., as stored within customer data 144A or digital activity data 144D of FIG. 1). For example, user 110 may specify an interest in health and fitness within the profile data, and system 140 may identify in step 216 one or more securities issued by corporate entities that provide goods and services related to health and fitness (e.g., securities issued by Under Armor™, which manufactures and sells exercise equipment and apparel).

In further instances, in step 216, system 140 may be configured to derive user 110's interest in one or more topics (e.g., health and fitness), based on the user 110's history of prior digital activities and/or consumption of electronic content (e.g., using the obtained digital activity data). For example, based on the obtained digital activity data, transaction server 142 may determine that user 110 accesses an online portion associated with a membership at an Equinox™ health club, and “likes” or “follows” Nike™ running shoes within a corresponding social network. Transaction server 142 may determine that the user has an interest in health and fitness, and in some embodiments, may tailor the one or more suggested securities identified in step 216 to reflect the determined interest. For instances, system 140 may not only identify suggested securities that include common stock issued by Nike™, but may also suggest securities issued by Whole Food Markets™, which markets healthy and organic food, and not securities issued by fast food chains, such as McDonalds™.

System 140 may execute software instructions that obtain, determine, generate, and/or identify an investment risk tolerance associated with user 110 (e.g., in step 218). The disclosed embodiments may be configured to determine and store an investment risk tolerance in different formats (e.g., within data repository 144 of FIG. 1). For instance, system 140 may be configured to generate the risk tolerance for user 110 in the form of a numerical score. In one example, an investment risk tolerance score value may range from one to ten, with a risk tolerance of one indicating that user 110 is highly averse to risk within an investment portfolio, and a risk tolerance of ten indicating user 110's acceptance of substantial risk in the investment portfolio. The disclosed embodiments may also execute software processes to generate an investment risk tolerance in other formats, such as graphical representations (e.g., sliding scale, color codes, or other formats).

In one embodiment, system 140 may be configured to execute software instructions that enable a user to specify the investment risk tolerance score, e.g., at an initial registration to access investment products associated with the financial institution. The specification of the investment risk tolerance score may, however, be appropriate for only experienced investors that have a clear idea of the level of risk with which they may comfortably purchase securities, and further, the extent to which financial risk can be tolerated before liquidating their position in the securities.

In contrast, inexperienced investors may have little or no idea how to gauge their individual risk tolerance. Moreover, while a lengthy and detailed questionnaire may assist an inexperienced user in gauging a personal risk tolerance, the length and breadth of such questionnaires may be daunting to a new investor and may represent a barrier that prevents the new investor from exploring investment opportunities available at the financial institution. Thus, in some embodiments, system 140 may execute software processes that present user 110 with an interface that enables user 110 to provide feedback, such as an interactive game process that poses one or more questions indicative of user 110's risk tolerance in an entertaining fashion.

In an embodiment, the interactive game may enable user 110 to select an avatar that graphically represents user 110, user 110's alter ego, or a character within the game. Avatars consistent with the disclosed embodiments may include three-dimensional forms (e.g., as in games or virtual worlds) and two-dimensional forms (e.g., an icon in Internet forums and other digital communities). By way of example, system 140 may enable user 110 to select an avatar that includes a three-dimensional animated character that asks questions and interacts with the client in an entertaining way.

The disclosed embodiments may be configured to perform processes that enable the avatar to pose questions to user 110 via client device 104 to elicit responses indicative of user 110's investment risk tolerance. For example, the questions may include, but are not limited to, queries about user 110's preferred activities, preferred products, and situational or anecdotal choices. User 110 may provide appropriate responses to the questions posed by the avatar, which include, but are not limited to, a voice input, a textual input, and a gestural input on a surface of a touchscreen, and transaction server. In some instances, system 140 may process the received responses to determine the investment risk tolerance score of user 110.

Further, in step 218, system 140 may adaptively modify the investment risk tolerance score in accordance with one or more securities currently held by the customer, or alternatively, in response to a history of user 110's purchases and sales of securities over a predetermined time period (e.g., one month, six month, or one year). For example, system 140 may be configured to obtain information in step 216 that identifies user 110 is highly averse to risk, e.g., an investment risk tolerance score of unity. As described herein, the investment risk tolerance score may be specified by user 110, or alternatively, determined by system 140 as a result of an interactive, avatar-based game. System 140 may, however, determine that user 110 regularly engaged in the day trading of highly speculative securities, such as futures contracts, stock options, and currencies, over a six-month period (e.g., based on information obtained from one or more data stored, such as data repository 144).

In some embodiments, system 140 may transmit an alert to client device 104 that identifies the inconsistency between that user's history of financial services transactions and the investment risk tolerance score, and further, that invites user 110 to modify the investment risk tolerance score to indicate a greater or lesser acceptance of risk. Additionally or alternatively, system 140 may automatically adapt, without user input, the investment risk tolerance score to be consistent with user 110's purchases and sales of securities over a predetermined period (e.g., six months).

System 140 may process the available securities related to user 110's digital activity data (e.g., as identified in step 216) to select a subset of the related available securities that are consistent with user 110's investment risk tolerance score. For example, system 140 may determine in step 216 that common stock issued by Toronto-Dominion Bank™, Unilever™, TimeWarner™, Comcast™, and Amazon.com™, may be of potential interest to user 110 based on user 110's social media activities and consumption of electronic content. Further, for example, system 140 may determine that user 110 is moderately risk averse (e.g., associated with an investment risk tolerance score of 3).

In such an embodiment, system 140 may, in step 220, select the common stock issued by Toronto-Dominion Bank™, Unilever™, and Comcast™ as “suggested” securities, as these securities are of potential interest to user 110 based on user 110's digital activity data, and are consistent with user 110's investment risk tolerance. In certain aspects, the determination of a level of risk associated with the available securities related to user 110's digital activity data based on factors that include, but are not limited to, a past performance of the securities, based on one or more prior financial services transactions of user 110 that involve the securities, and/or based on one or more quarterly earnings reports of the corresponding issuers.

In step 222, system 140 may determine whether a “watch list” should be generated for user 110, or alternatively, whether an existing watch list should be updated, based the suggested securities (e.g., as identified in step 220). As described above, a “watch list” may include one more securities, corporations, or other entities of interest to user 110, and system 140 may provide updates (e.g., real-time or at periodic intervals) on a performance of the securities, companies, and entities. Further, in an embodiment, system 140 may create a watch list for user 110 independently of and subsequent to the creation of an actual or virtual investment portfolio of the customer, and further, the watch list may include additional securities of interest not included within either of the customer's virtual or actual investment portfolios.

For example, system 140 may determine whether information identifying stock issued by Toronto-Dominion Bank™, Unilever™, and Comcast™ should be included within an existing watch list or should form the basis of a new watch list. Further, in additional embodiments, system 140 may determine whether any other securities or issuers should be added to the watch list based on, e.g., purchases of securities or additional transactions occurring within a predetermined prior time period (e.g., thirty days).

If system 140 determines that the watch list should be generated or updated based on the suggested securities (step 222; YES), system 140 may update the watch list or create the watch list in step 224. For example, in step 224, system 140 may add information identifying the stocks issued by Toronto-Dominion Bank™, Unilever™, and Comcast™ to the watch list. System 140 may generate and transmit updates regarding the securities on the watch list to client device 104 at various intervals (e.g., at period intervals, at specified intervals (such as daily or weekly), or in response to certain market events (such as a decline in an index of a specified amount), as described above. Process 200 is then complete in step 210.

If, however, system 140 determines that a watch list should neither be generated nor updated (e.g., step 222; NO), system 140 may determine whether user 110 is associated with an existing investment portfolio in step 226. For example, system 140 may access portfolio data associated with one or more user of the financial institution (e.g., portfolio data 144C of FIG. 1) to determine whether user 110 is associated with a “actual” investment portfolio including actual positions in one or more securities, and additionally or alternatively, a “virtual” investment portfolio including simulated positions in one or more securities.

If system 140 determines that user 110 is associated with an actual or virtual investment portfolio (step 226; YES), system 140 may obtain portfolio data corresponding to user 110's actual investment portfolio, and additionally or alternatively, user 110's virtual investment portfolio (e.g., in step 228). For example, system 140 may access a data repository associated with the financial institution (e.g., portfolio data 144C of FIG. 1) to obtain the portfolio data for the customer's actual and/or virtual investment portfolios.

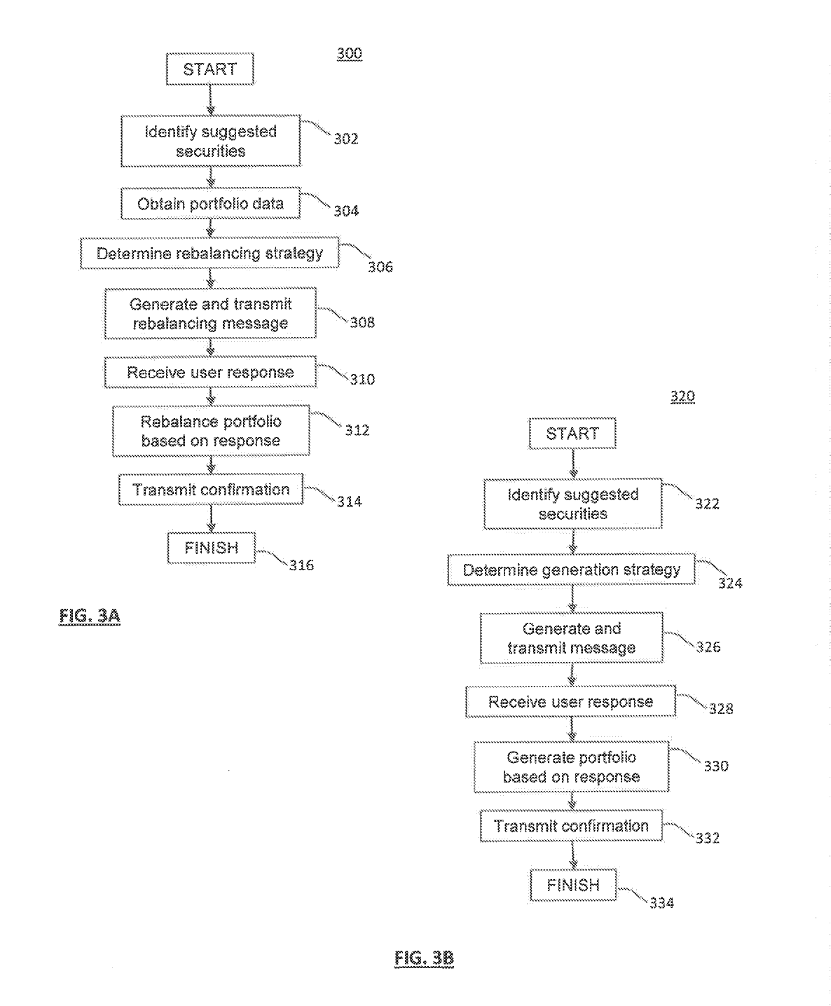

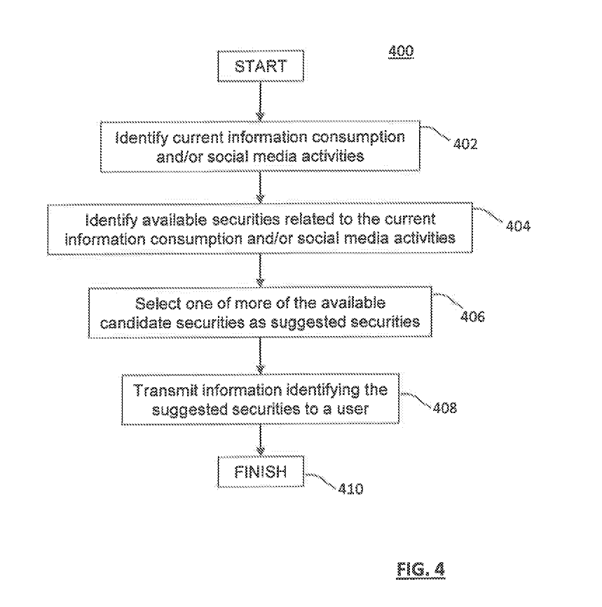

System 140 may also determine and implement a strategy for rebalancing the actual investment portfolio and/or the customer's virtual investment portfolio of user 110 based on, for example, the obtained portfolio data and the suggested securities (e.g., in step 228). In an embodiment, user 110's actual investment portfolio (and additionally or alternatively, user 110's virtual investment portfolio) may be associated with a target asset allocation defined by, for example, the customer's investment risk tolerance score and one or more investment goals of the customer. In some embodiments, the rebalancing strategy determined by system 140 may increase a position in one or more under-represented securities (e.g., virtually or through an actual purchase of the under-represented securities) and may decrease a position in one or more over-represented securities (e.g., virtually or through a sale of the over-represented securities) in order to bring user 110's investment portfolio back into line with the target asset allocation. Exemplary process relating to determining and implementing a strategy for rebalancing an actual investment portfolio and/or a virtual investment portfolio of a customer in accordance with disclosed embodiments is described below in reference to FIG. 3A.

In some aspects, system 140 may determine the rebalancing strategy based on a pattern of recurring user behavior, and additionally or alternatively, based on changes in this recurring behavior. For example, based on the obtained digital activity data (e.g., obtained from digital activity data 144D in step 212), system 140 determine that user 110 consumed streaming video content provided by NBC™ news, and may further determine that user 110's actual investment portfolio includes common stock issued by Comcast™ (i.e., the corporate parent of NBC™). If, however, transaction server 142 monitors the obtained digital activity data and determines that the recurring consumption of NBC™ news content fail to continue, transaction server 142 may determine a rebalancing strategy for the user's actual investment portfolio that reduces or eliminates the user's position in Comcast™ common stock. Further, in some instances, system 140 may determine that instead of streaming content provided by NBC™, user 110 regularly views content provided by ABC™ news (e.g., greater than a threshold number of content-streaming events in a predetermined time period). In response to the determination, system 140 may be configured to generate a rebalancing strategy for user 110's actual investment portfolio that increases user 110's position in common stock issued by Disney™ (i.e., the corporate parent of ABC™).

Further, in some instances, system 140 may perform a rebalancing process that modifies an implementation on one or more existing investment programs in which user 110 participates. For example, the user may participate in a DRIP provided by Comcast™, which may facilitate the reinvestment of dividend income into additional securities issued by Comcast™. In an embodiment, and based on the obtained digital activity data, system 140 may identify a rebalancing strategy that directs at least a portion of the user's income from Comcast™ dividends not into additional Comcast™ securities, but into positions in other securities that better reflect the social networking activity and/or electronic content consumption of user 110, user 110's friends, and/or user 110's family. For example, transaction server 142 may generate a rebalancing strategy that, based on user 110's viewing of web pages related to global warming, redirects dividend income into a startup company manufacturing high-efficiency solar panels.

Upon identification and implementation of the rebalancing strategy in step 228, exemplary method 200 is complete in step 210. If, however, system 140 determines that user 110 is not associated with an actual or virtual investment portfolio (step 226; NO), system 140 may identify and implement a strategy for creating an actual investment portfolio, a virtual investment portfolio, or any combination of actual and virtual investment portfolios (e.g., in step 230). For example, and as described below in reference to FIG. 3B, system 140 may identify the portfolio strategy based on, among other things, the one or more suggested securities and the investment risk tolerance of user 110. Further, in step 230, system 140 may perform a portfolio generation process that modifies an implementation on one or more existing investment programs (e.g., DRIPs) in which user 110 participates, as described above. Upon identification and implementation of the generation strategy in step 230, exemplary method 200 is complete in step 210.

FIG. 3A is a flowchart of an exemplary process 300 for determining and implementing a strategy for rebalancing an actual investment portfolio and/or a virtual investment portfolio of a customer, in accordance with disclosed embodiments. In one embodiment, a system associated with a financial institution (e.g., system 140 associated with business entity 150) may be configured to determine a strategy for rebalancing an actual investment portfolio and/or a virtual investment portfolio of user 110 based on, for example, one or more suggested securities and a current state of the actual and/or virtual portfolio of user 110, and to implement the rebalancing strategy based on input received from user 110. For example, method 300 may be incorporated into step 228 of FIG. 2 to rebalance the actual and/or virtual investment portfolio of user 110.

In step 302, system 140 may obtain information identifying one or more suggested securities of potential relevance to user 110 based on, for example, elements of content consumed by user 110. By way of example, and as described herein, the consumed content may include, but is not limited to, social media data associated with user 110, news feeds to which user 110 subscribes, content within web pages viewed by user 110, and/or search queries submitted by user 110 to corresponding search engines.

System 140 may obtain information identifying one or more of a virtual investment portfolio or user 110 and an actual investment portfolio of user 110 in step 304. In certain aspects, system 140 may obtain the portfolio data from a corresponding portion of data repository 144 (e.g., portfolio data 144C), and the obtained portfolio data may include, but is not limited to, information identifying one or more securities held within the actual and/or virtual investment portfolio, and actual and/or virtual positions in these securities,

By way of example, system 140 may identify suggested securities that include stock issued by Toronto-Dominion Bank™, Unilever™, and Comcast™, and further, may determine that user 110 is generally risk averse (e.g., associated with an investment risk tolerance score of 3). Further, based on the obtained portfolio data, system 140 may determine that user 110's actual investment portfolio includes no Unilever™ stock, 150 shares of The Toronto-Dominion Bank™, and 150 shares of Comcast™ stock.

In certain aspects, system 140 may execute software instructions to implement a rebalancing process that executes a rebalancing strategy equalizing user 110's position in Toronto-Dominion Bank™, Unilever™, and Comcast™ stock within the actual investment portfolio (e.g., in step 306). For example, system 140 may identify: (i) a first balancing strategy that leverages available cash to purchase 100 shares of Unilever™ on a corresponding market; (ii) a second balancing strategy that includes selling fifty shares of The Toronto-Dominion Bank™ common stock and fifty shares of Comcast™ common stock to finance a purchase of 100 shares of Unilever™ common stock; and/or (iii) a third balancing strategy that includes selling other securities in the actual investment portfolio to finance the purchase of 100 shares of Unilever™ stock.

In some embodiments, system 140 may generate the rebalancing strategy in step 306 based on user 110's investment risk tolerance score, and further, based on one or more investment goals specified by user 110 and stored in a corresponding data repository, e.g., within portfolio data 144C of FIG. 1. For example, such investment goals include, but are not limited to, a specified cash reserve associated with the actual or virtual investment portfolio, a maximum value of all securities and cash within the actual or virtual investment portfolio, and a ratio of debt instruments (e.g., bonds) to equity instruments (e.g., common stock) within the actual or virtual investment portfolio.

Additionally or alternatively, an investment advisor associated with the financial institution may interact with system 140, and further, with user 110 at client device 104, to develop the rebalancing strategy based on user 110's investment risk tolerance score, the investment goals, and further, other intangible information identified by the financial advisor during face-to-face, voice, or electronic communications with user 110. For example, such intangible information may include, but is not limited to, an ability of user 110 to rapidly liquidate one or more potions of the actual or virtual investment portfolio and a need to liquidate the portfolio within a predetermined time period (e.g., a need to finance a child's education).

Referring back to FIG. 3A, in step 308, system 140 may generate a message that alerts user 110 to the rebalancing of the actual investment portfolio, identifies the rebalancing strategy or strategies, and request user 110's input on and approval of the rebalancing. For example, the generated rebalancing message may enable user 110 to select one of the rebalancing strategies for execution, request that no rebalancing occur, and additionally or alternatively, to provide information identifying an alternate rebalancing strategy. System 140 may transmit the rebalancing message across network 120 to client device 104 using, for instance, any of the communications protocols outlined above.

Upon receipt of the rebalancing message, client device 104 may execute software processes that render and display the received message within a corresponding interface. User 110 may select a desired rebalancing strategy, and client device 104 may incorporate user 110's selection into a corresponding response, client device 104 may be transmitted across network 120 to system 140 using any of the communications protocols outlined above.

System 140 may receive the response from client device 104 (e.g., step 310), and rebalance user 110's actual (or virtual) investment portfolio based on the received response (e.g., step 312). For example, the received response may indicate user 110's selection of the second rebalancing strategy, i.e., the sale of fifty shares of The Toronto-Dominion Bank™ common stock and fifty shares of Comcast™ common stock to finance a purchase of 100 shares of Unilever™ common stock. In some embodiments, system 140 may rebalance the actual investment portfolio by generating instructions to initiate and execute one or more financial services transactions to sell the fifty shares of The Toronto-Dominion Bank™ common stock and fifty shares of Comcast™ common stock and to purchase the 100 shares of Unilever™ common stock.

In certain aspects, system 140 may generate a confirmation of the rebalanced portfolio (e.g., step 314), which system 140 may transmit to client device 104 over network 120, and additionally or alternatively, to a client device operated by an investment advisor. In certain aspects, system 140 may provide the confirmation using any of the communications protocols described herein. For example, the confirmation may identify one or more financial services transactions executed to rebalance the portfolio (e.g., the sale of fifty shares of The Toronto-Dominion Bank™ common stock and fifty shares of Comcast™ common stock, and the purchase of 100 shares of Unilever™ common stock), a current composition of the actual investment portfolio, and one or more characteristics of the actual investment portfolio (e.g., a total value and a debt-to-equity ratio). Exemplary method 300 is then complete in step 316.

FIG. 3B is a flowchart of an exemplary process 320 for determining and implementing a strategy for generating an actual and/or virtual investment portfolio for a customer, in accordance with disclosed embodiments. In one embodiment, a system associated with a financial institution (e.g., system 140 associated with business entity 150) may be configured to determine a strategy for generating an actual investment portfolio and/or a virtual investment portfolio for user 110 based on, for example, one or more suggested securities and an investment risk tolerance associated with user 110. For example, method 320 may be incorporated into step 230 of FIG. 2 to generate the actual and/or virtual investment portfolio of user 110.

In step 322, system 140 may obtain information identifying one or more suggested securities of potential relevance to user 110 based on, for example, one or more elements of media consumed by user 110. By way of example, and as described herein, the consumed media may include, but is not limited to, social media data associated with user 110, news feeds to which user 110 subscribes, content within web pages viewed by user 110, and/or search queries submitted by user 110 to corresponding search engines. In step 324, system 140 may be configured to determine a strategy for generating an actual and/or virtual investment portfolio for user 110 based on, among other things, the information identifying the suggested securities and the investment risk tolerance of user 110.

As described above, system 140 may determine that common stock issued by Toronto-Dominion Bank™, Unilever™, and Comcast™ are consistent with the customer's investment risk tolerance and might be of potential interest to the customer. In certain aspects, system 140 may determine a strategy in step 324 for generating an actual investment portfolio that includes the common stock of Toronto-Dominion Bank™, Unilever™, and Comcast™. For example, and as described herein, the portfolio generation strategy may be based on one or more investment goals, which include, but are not limited to, a specified cash reserve associated with the actual or virtual investment portfolio, a maximum value of all securities and cash within the actual or virtual investment portfolio, and a ratio of debt instruments (e.g., bonds) to equity instruments (e.g., common stock) within the actual or virtual investment portfolio.

Additionally or alternatively, an investment advisor associated with the financial institution may interact with system 140, and further, with user 110 at client device 104, to develop the portfolio generation strategy based on the customer's investment risk tolerance score, the investment goals, and further, other intangible information identified by the financial advisor during face-to-face, voice, or electronic communications with the customer, as described herein.

For example, system 140 may determine a portfolio generation strategy in step 324 that equalizes the customer's position in Toronto-Dominion Bank™, Unilever™, and Comcast™ stock, or alternatively, emphasizes a position in either one of the Toronto-Dominion Bank™, Unilever™, and Comcast™ stock (e.g., since one of the corporations is expected to provide a divided over a predetermined time period). In such an embodiment, system 140 may identify: (i) a first portfolio generation strategy that includes purchasing 100 shares of The Toronto-Dominion Bank™ stock, 100 shares of Unilever™ stock, and 100 shares of Comcast™ stock; (ii) a second portfolio generation strategy that includes purchasing 200 shares of The Toronto-Dominion Bank™ stock, fifty shares of Unilever™ stock, and fifty shares of Comcast™ stock; (iii) a third portfolio generation strategy that includes purchasing fifty shares of The Toronto-Dominion Bank™ stock, 200 shares of Unilever™ stock, and fifty shares of Comcast™ stock; and (iv) a fourth portfolio generation strategy that includes purchasing fifty shares of The Toronto-Dominion Bank™ stock, fifty shares of Unilever™ stock, and 200 shares of Comcast™ stock.

System 140 may generate a message that alerts user 110 to the creation of the actual investment portfolio, identifies the portfolio creation strategy or strategies, and request user 110's input on and approval of the creation of user 110's actual investment portfolio (e.g., in step 326). For example, the generated message may request that user 110 select one of the portfolio generation strategies for execution, or alternatively, provide input cancelling the portfolio generation or identifying an alternate strategy for generating the actual investment portfolio. System 140 may, in one example, transmit the message in step 326 across network 120 to client device 104, such as through any of the communications protocols described herein.

Upon receipt of the message, client device 104 may execute software processes to render the received message for display on an interface of a display of client device 104. Client device 104 may execute software processes that enable user 110 to select a desired portfolio generation strategy through the interface (and other input mechanisms). In one aspect, client device 104 may incorporate user 110's selection into a corresponding response, which may be transmitted across network 120 to system 140 using any of the communications protocols described herein.

System 140 may receive the response (e.g., in step 328), and may generate user 110's actual investment portfolio based on the received response (e.g., in step 330). For example, the received response may indicate user 110's selection of the second portfolio generation strategy, e.g., the purchase of 200 shares of Toronto-Dominion Bank™ stock, fifty shares of Unilever™ stock, and fifty shares of Comcast™ stock. In such an embodiment, system 140 may generate the actual investment portfolio in step 330 by executing one or more financial services transactions to purchase the 200 shares of The Toronto-Dominion Bank™ stock, fifty shares of Unilever™ stock, and fifty shares of Comcast™ stock.

System 140 may generate a confirmation of the created portfolio, which may be transmitted in step 332 to client device 104 over network 120 using any of the communications protocols outlined above. For example, the confirmation may identify one or more financial services transactions executed to create the portfolio (e.g., the purchase of 200 shares of The Toronto-Dominion Bank™ stock, fifty shares of Unilever™ stock, and fifty shares of Comcast™ stock), a current composition of the actual investment portfolio, and one or more characteristics of the actual investment portfolio (e.g., a total value and a debt-to-equity ratio). Upon transmission of the confirmation message in step 332, exemplary process 320 may be complete in step 334.

In some exemplary embodiments, system 140 may rebalance an existing actual investment portfolio, and additional or alternatively, may create an new actual investment portfolio, based on a user's response to an alert identifying one or more proposed rebalancing or creation strategies. The disclosed embodiments are not limited to rebalancing and creation operations performed in response to specific user input, and in additional embodiments, system 140 may automatically rebalance an existing actual investment portfolio or create a new actual investment portfolio without explicit user authorization.

For example, user 110 may be an experienced investor, and may specify within corresponding profile data (e.g., as stored within customer data 144A of FIG. 1) that system 140 may automatically rebalance or create an actual investment portfolio without approval if the rebalanced or generated investment portfolio conforms to specific investment goals. Such investment goals include, but are not limited to, a specified cash reserve associated with the actual investment portfolio, a maximum value of all securities and cash within the actual investment portfolio, and a ratio of debt instruments to equity instruments within the actual (or virtual) investment portfolio. Further, in an embodiment, user 110 may specify one or more authorized financial services transactions (e.g., a sale or purchase or a particular security) that may be executed by system 140 as part of a portfolio creation or rebalancing strategy without prior explicit approval.

Further, in certain embodiments, system 140 may be configured to rebalance an actual investment portfolio of user 110, or alternatively, generate an actual investment portfolio for user 110. The disclosed embodiments are, however, not limited to actual investment portfolios, and in additional embodiments, the exemplary techniques described above can be applied to rebalance an existing virtual portfolio of a user based on, for example, transaction data of user 110, user 110's investment risk tolerance, and one or more investment goals of user 110. For example, system 140 may identify one or more rebalancing strategies for the virtual investment portfolio, and in response to an authorization of user 110, generate simulated positions in the suggested securities in accordance with user 110's selected rebalancing strategy.

Similarly, the exemplary techniques described above may be applied to generate a new virtual investment portfolio for user 110 based on, for example, transaction data of user 110, user 110's investment risk tolerance, and one or more investment goals of user 110. In such embodiments, system 140 may identify one or more generation strategies for the virtual investment portfolio based on suggest securities of potential interest to user 110, receive a selection of one of the portfolio generation strategies from user 110, and generate “simulated” positions in the suggested securities in accordance with user 110's selection.

Further, the disclosed embodiments are not limited to rebalancing and generating either an actual investment portfolio or a virtual investment portfolio. In additional embodiments, user 110 may be associated with one or more actual investment portfolios and one or more virtual investment portfolios (which may securities with the actual investment portfolios), and the exemplary techniques described above may enable system 140 to rebalance each of the existing actual and virtual investment portfolios concurrently or sequentially, and further, to generate any number of additional actual or virtual investment portfolios appropriate to user 110.

In certain embodiments, the virtual investment portfolios rebalanced or created by system 140 may correspond to one or more attributes of an actual investment portfolio, had it been purchased by user 110. By monitoring a virtual portfolio, or alternatively, by creating a watch list of various investments, user 110 may see what financial gains or losses would have been made, had user client actually purchased the stocks in the virtual investment portfolio and/or the watch list. Further, virtual investment portfolios consistent with the disclosed embodiments may include investments held by user 110 (e.g., in an actual investment portfolio) and others not held by user 110. Additionally, securities in user 110's watch list may be monitored over time to review performance with respect to user 110's actual or virtual investment objectives.

In the embodiments described above, system 140 may identify one or more “suggested” securities (e.g., stock issued by Toronto-Dominion Bank™, Unilever™, and Comcast™) that are of potential interest user 110 based on user 110's prior social media activities and information consumption, and further, that are associated with a level of risk consistent with user 110's investment risk tolerance score. As described above, user 110 may obtain information identifying the suggested securities through an interface of a digital portal provided by business entity 150 (e.g., a financial institution associated with system 140) and presented by user device after corresponding authentication step. Through the digital portal, user 110 may generate or modify a “virtual” investment portfolio, and additionally or alternatively, a “watch list,” composed of simulated positions in one or more of the suggested securities (e.g., equity positions in equity securities and creditor positions in debt securities).

The disclosed embodiments are, however, not limited to techniques that provide user 110 with information identifying “suggested securities” through a corresponding digital portal accessible through client device 104. In additional embodiments, system 140 may provide information identifying the one or more suggested securities to client device 104 for real-time presentation to user 110 as, for example, a “pop-up” window or other interface element that provides real-time information to user 100. Further, system 140 may identify the one or more suggested securities based not only on user 110's prior social media activities and information consumption, but also on information and content (e.g., a web page) currently consumed by user 110 and/or a current social media activity of user 110 (e.g., a new posting or comment on a prior posting, a new connection with an individual or business entity, or a new tag applied to an image).

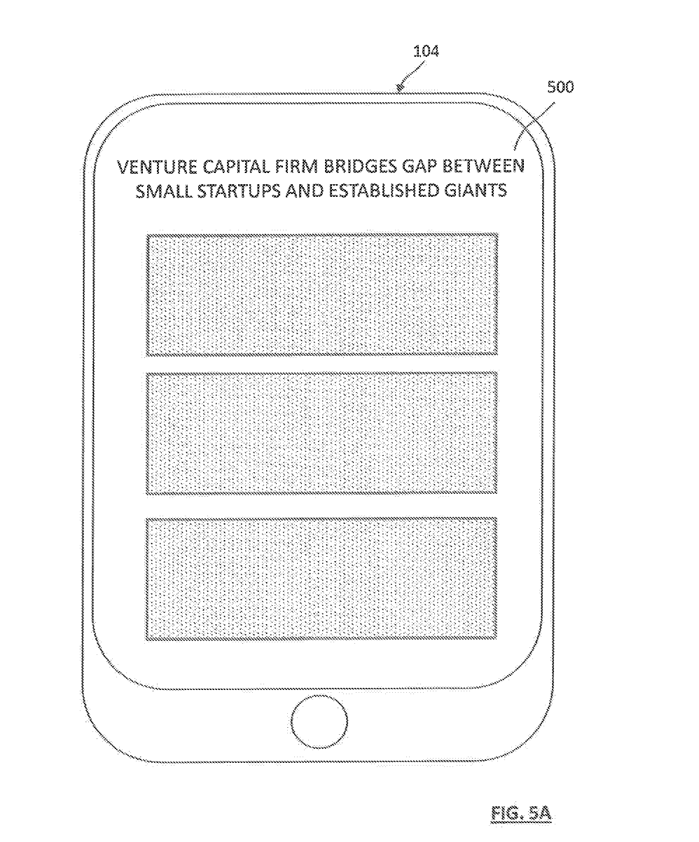

FIG. 4 illustrates an exemplary process 400 for identifying one or more securities of potential interest to a user, consistent with disclosed embodiments. In one embodiment, a system associated with a financial institution (e.g., system 140 associated with business entity 150) may be configured to obtain data identifying user 110's current consumption of electronic content and/or current participation in one or more social networks, and may be further configured to suggest one or more securities (e.g., common stocks, bonds, and/or derivatives contracts) related to the consumed electronic content and/or the social media participation. In some aspects, the suggested securities may conform to an investment risk tolerance of user 110, and may be transmitted to a device of user 110 (e.g., client device 104) for real-time presentation to user 110.

System 140 may be configured to execute software instructions to identify a current consumption of information by user 110 and/or a current interaction of user 110 with one or more social networks (e.g., in step 402). In some embodiments, system 140 may be configured to determine the current information consumption and/or current social media activities at predetermined or user-specific times (e.g., every fifteen minutes, every hour, etc.). In other aspects, system 140 may be configured to determine the current information consumption and/or current social media activities in response to a request for suggested securities received from client device 104.

By way of example, system 140 may determine the current information consumption and/or current social media activities based on digital data activity obtained from one or more data stores (e.g., digital data store 144D of data repository 144) and additionally or alternatively, from systems associated with one or more external data providers (e.g., system 160), as described above. The digital activity data may include, but is not limited to, social networking data indicative of user 110's participation in one or more social networks (e.g., Facebook™, Twitter™, and/or LinkedIn™), and information consumption data indicative of one or more elements of electronic content (e.g., web pages, news feeds, electronic books, streaming audio and/or video, podcasts, etc.) consumed by user 110.

In other aspects, system 140 may be configured to determine the current information consumption and/or current social media activities in response to a request for suggested securities received from client device 104. In some aspects, client device 104 may be configured to monitor the current media consumption, social networking activities, and other digital activities of user 110, and to transmit information indicative of the monitored activities to system 140 at periodic or regular intervals, or in response to predetermined events (e.g., then client device 104 enters a “standby” mode or is powered off by user 110, or user 110 open a new browser window or enters a new URL into an existing browser window.).

In step 404, system 140 may identify available securities that are relevant to the current information consumption and/or current social networking activity of user 110, and thus, that may be of potential interest to user 110. For example, using one or more of the exemplary techniques described above, system 140 may identify securities available for incorporation into an actual investment portfolio, a virtual investment portfolio, and/or a watch list associated user 112. Further, using one or more of the comparative, natural language search, or semantic search techniques identified above, system 140 may determine that a subset of the available securities are relevant to information recently consumed by user 110 (e.g., an issuer of a candidate security may be mentioned within a web page currently viewed by user 110) and/or a current social networking activity of user 110 (e.g., a new posting or comment on prior posting, a new connection with an individual or business entity, or a new tag submitted for an image).

In step 406, system 140 may further select, as suggested securities, one or more of the available candidate securities are of potential interest to user 110 based on user 110's the current information consumption and/or current social media activity, and further, are associated with a level of risk consistent with user 110's investment risk tolerance score. In certain aspects, system 140 may leverage one or more of the techniques described above to determine an investment risk tolerance of user 110 and/or dynamically adapt a previously determined investment risk tolerance. For example, and as described above, the investment risk tolerance may be expressed as a numerical score ranging from unity (e.g., indicating user 110 is very risk averse) to ten (indicating that user 110 is very risk tolerant).

System 140 may execute software instructions to generate and transmit information identifying at least a portion of the suggested securities to client device 104 (e.g., in step 408). By way of example, system 140 may transmit the information to client device 104 across network 120 using one or more of the communications protocols outlined above. Upon transmission of the information identifying the portion of the suggested securities to client device 104, exemplary process 400 is complete in step 410.

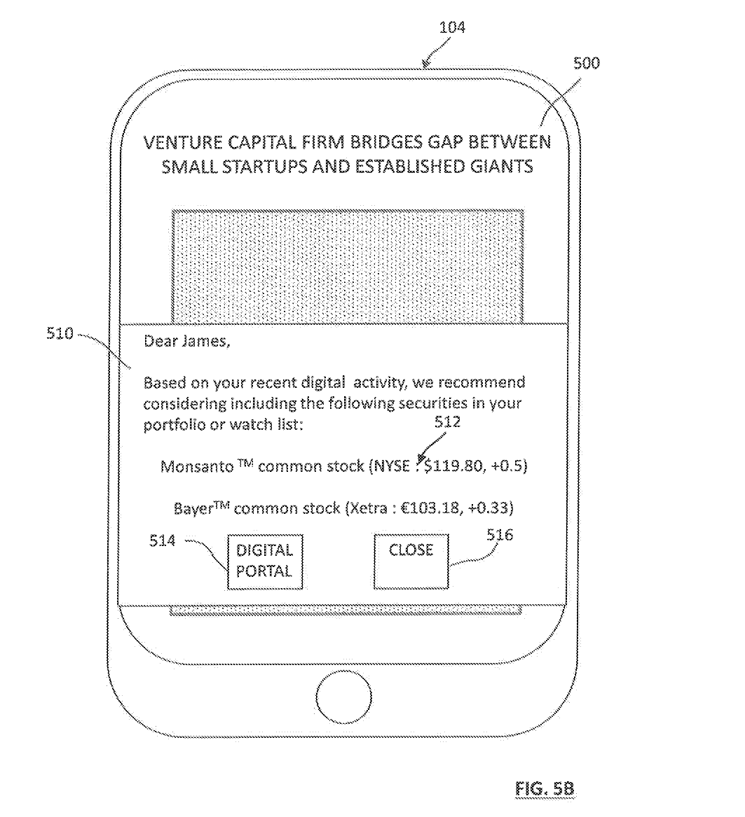

In some aspects, upon receipt of the transmitted information, client device 104 may render the information for presentation to user 110. Client device 104, in some instances, may execute an application (e.g., a mobile “app” provided by system 140) that receives, renders, and presents the information within a “pop-up” or other interface element that obscures at least a portion of additional content presented to user 110. By way of example, as illustrated in FIG. 5A, client device 104 may execute software that provides a web page (e.g., web page 500) on a display device for viewing by a user (e.g., user 110). In this example, web page 500 may describe instances in which venture capital firms facilitate funding and purchase of small, innovative biotechnology startups by larger chemical and biotechnology conglomerates, such as Monsanto™ and Bayer™. System 140 may execute software that performs process(es) that may identify the information currently consumed by user 110, and determine that the investment risk score of user 110 (e.g., a relatively risk-averse score of three) is incompatible with the elevated risks associated with positions in small firms, but may be appropriate for investment in the larger and more stable biotechnology and chemical conglomerates (e.g., Monsanto™ and Bayer™).

In some aspects, and as described above, system 140 may identify available common stocks issued by Monsanto™ and Bayer™ as suggested securities that conform to the investment risk profile of user 110 and may be of potential interest to user 110 based on user 110's current information consumption. System 140 may, for example, transmit information identifying these suggested securities to client device 104 for presentation to user 110.

FIG. 5B shows an exemplary interface that may be provided by client device 104 consistent with certain disclosed embodiments. Client device 104 may, for example, receive the receive, render, and present the information within a pop-up or other interface 510 that obscures at least a portion of additional content presented to user 110. For example, client device 104 may present interface 510 concurrently with web page 500 such that a portion of web page 500 is obscured. Further, in FIG. 5B, information 512 may indicate that, based on current information consumption, common stocks issued by Monsanto™ and Bayer™ might be of interest to user 110. Further, in some embodiments (not shown) information 512 may also include a stock symbols for Monsanto™ and Bayer™ on corresponding exchanges, and additionally or alternatively, information specifying a performance of the securities during a prior or ongoing trading session (e.g., changes in share price and/or a trading volume).

In FIG. 5B, interface 510 may also include a region 514 that, upon selection by user 110, may enable user 110 to access a digital portal associated with a system of a financial institution (e.g., system 140). By way of example, and as described above, the digital portal may present information identifying the suggested securities (e.g., the common stock issued by Monsanto™ and Bayer™) to user 110, and user 110 may further interact with the digital portal to generate or modify an actual or “virtual” investment portfolio, and additionally or alternatively, a “watch list,” composed of simulated positions in one or more of the suggested securities. In some aspects, user 110 may click within, press, or otherwise select region 110 to gain access to the digital portion, which client device 104 may, for example, render and present to user 110 within a separate window or interface element.

In other aspects, interface 510 may include an additional region 516 that, upon selection by user 110, causes client device 104 to close, remove from view, and/or minimize interface 510. By way of example, user 110 may click within, press, or otherwise select region 110 to close interface 510 and continue to view web page 500 unobscured.

In some embodiments, and in addition to providing information identifying “suggested” securities to client device 104, system 140 may also provide to information identifying securities currently held by user 110 (e.g., within a mutual fund or retirement account) and relevant to user 110's current consumption of information and/or social networking activities. For example, user 110 may hold positions in a mutual fund that include common stock issued by manufacturing and mining companies, such as BHP Billiton Ltd.™, which operates mines in, among other places, South Africa. Furthermore, user 110 may be associated with an investment risk tolerance score of seven, indicating that user 110 is fairly tolerant of risk in a corresponding investment portfolio (e.g., held at a financial institution associated with system 140).

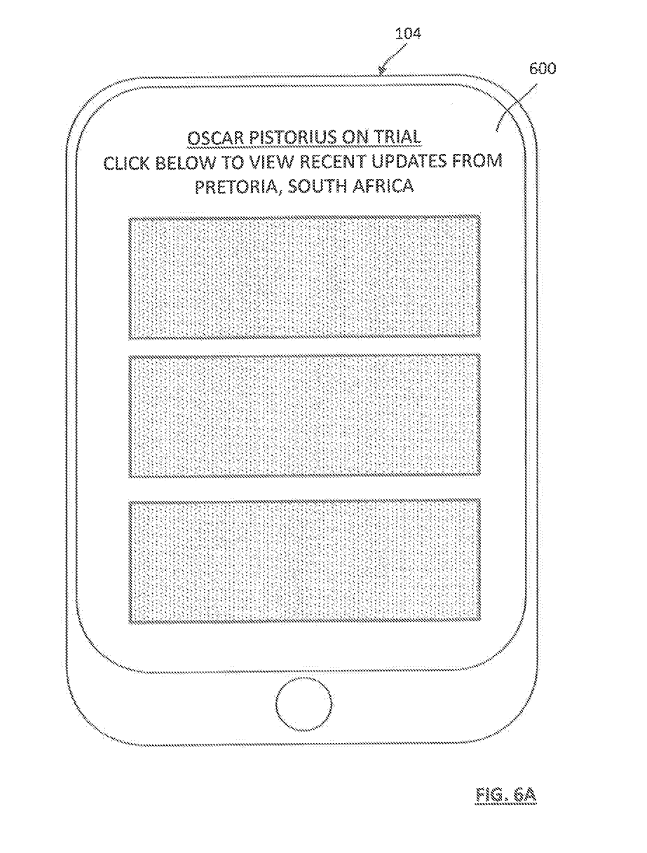

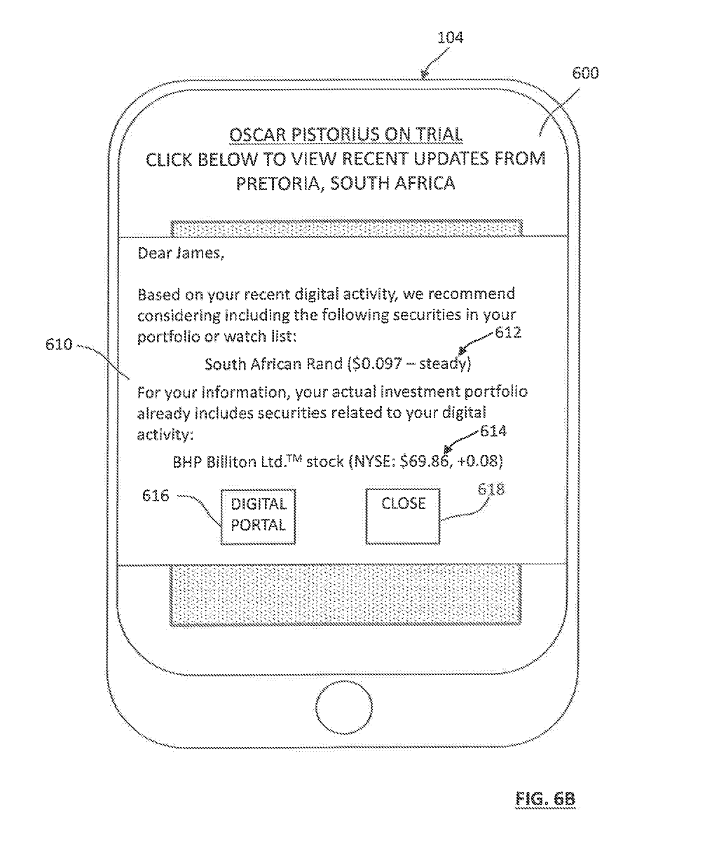

For example, FIG. 6A shows an exemplary interface that includes web page content 600 that may be provided by client device 104, consistent with disclosed embodiments. In this example, the exemplary web page 600 may include information and recent updates on the murder trial of Oscar Pistorius in Pretoria, South Africa. System 140 may be configured to identify the electronic content currently presented on client device 104, which may be viewed by user 110 (e.g., consumed by user 110), and may determine that currency transactions involving the South African rand may be of potential interest to user 110 based on user 110's currently consumption of South African legal news, and further, may comport with the investment risk tolerance of user 110.

In additional aspects, system 140 may also obtain information from one or more data stores (e.g., portfolio data 144C of data repository 144) and, as described above, determine that a mutual fund held by user 110 includes common stock issued by BHP Billiton Ltd.™, which operates mines in South Africa. Further, in some instances, system 140 may also obtain information identifying a performance of the mutual fund held by user 110 and/or the common stock issued by BHP Billiton Ltd.™ during a current or previous trading session.

In certain aspects, system 140 may transmit information identifying both the suggested security (e.g., positions in South African rand) and relevant portions of user 110's actual or virtual investment portfolio (e.g., the mutual fund and/or common stock issued by BHP Billiton Ltd.™) for presentation to user 110, via client device 104. FIG. 6B shows an exemplary interface that may be provided by client device 104 consistent with disclosed embodiments.

For example, client device 104 may receive the receive, render, and present the information within a pop-up or other interface 610 that obscures at least a portion of additional content presented in an interface for display to user 110. For example, client device 104 may present interface 610 concurrently with web page 600 such that a portion of web page 600 is obscured. In some aspects, interface 610 may include information 612 that identifies a security (e.g., the South African rand) of potential interest to user 110 and consistent with user 110's investment risk tolerance. By way of example, information 612 may recommend that user 110 purchase positions in the South African rand based on user 110's interest in South African legal affairs and user 110's acceptance of investment portfolio risk.

Further, for example, interface 610 may also include information 714 that identifies one or more securities that are currently held by user 110 (e.g., positions in a mutual fund that includes common stock issued by BHP Billiton Ltd.™) and further, that are relevant to a current information consumption of user 110. For example, information 614 may alert user 110 to the presence of common stock issued by BHP Billiton Ltd.™ within an actual investment portfolio, and may further provide information identifying a performance of the common stock and/or the corresponding mutual fund during a current or prior trading session. The information provided in the interface that may be displayed by client device 104 may be determined and provided by system 140 in accordance with one or more processes disclosed above.

In FIG. 6B, interface 610 may also include a region 616 that, upon selection by user 110, may enable user 110 to access a digital portal associated with system 140. As described above, the digital portal may enable user 110 to generate or modify an actual or “virtual” investment portfolio, and additionally or alternatively, a “watch list,” composed of simulated positions in one or more of the suggested securities. In some aspects, user 110 may click within, press, or otherwise select region 110 to gain access to the digital portion, which client device 104 may, for example, render and present to user 110 within a separate window or interface element. Furthermore, as described above, interface 610 may also include an additional region 618 that, upon selection by user 110, causes client device 104 to close, remove from view, and/or minimize interface element 610, and continue to view web page 600 unobscured.

Further, in some embodiments, one or more of the suggested securities may be relevant to recent activity of user 110 within a social media network (e.g., Facebook™, Twitter™, and/or LinkedIn™), and additionally or alternatively, may be relevant to other individuals or business entities whose activities user 110 monitors within the social media network. By way of example, and as described above, system 140 may access social media consumption data and determine that user 110 recently followed an individual, product, service, or business entity within the social media network. In certain aspects, system 140 may identify one or more securities to user 110 that are relevant to the product, service, and/or business entity (e.g., that are issued by the business entity or a corporate parent of the business entity, or that are issued by a manufacturer, retailer, or supplier associated with the product).

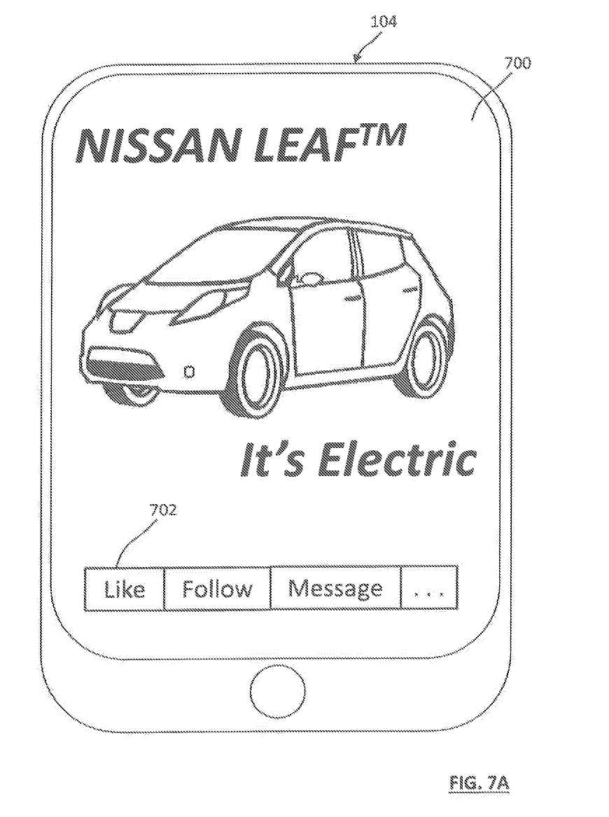

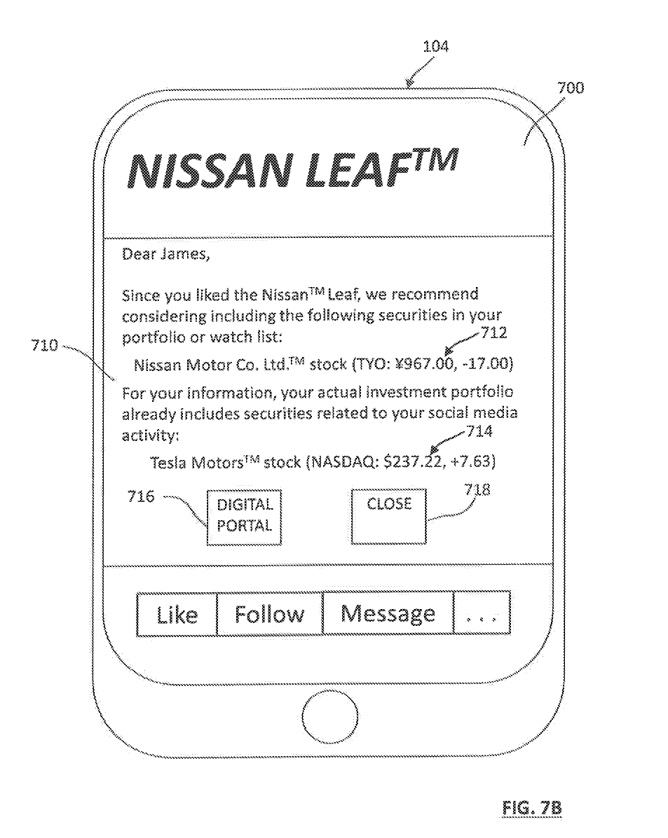

By way of example, as illustrated in FIG. 7A, client device 104 may execute software that provides social media content (e.g., content 700) on a display device for viewing by user 110. In this example, social media content 700 may disposed within a social media feed of user 110 and may describe Nissan Leaf™ electric vehicle. Social media content 700 may also include a region 702 that, upon selection by user 110, allows user 110 to “like” the sponsored content describing the Nissan Leaf™ electric vehicle.

In some aspects, system 140 may configured to perform processes that determine user 110 “liked” the content associated with the Nissan Leaf™ electric vehicle, and determine that the Nissan Motor Co. Ltd.™ manufactures the Nissan Leaf™ electric vehicle. Further, in some instances, system 140 may obtain information from one or more data stores (e.g., portfolio data 144C of data repository 144) and, as described above, may determine that a stock fund held by user 110 includes common stock issued by Nissan Motor Co. Ltd.™, which manufactures the Nissan Leaf™ electric vehicle. System 140 may also determine that common stock issued by Tesla Motors™, which manufactures electric vehicles, comports with an investment risk tolerance of user 110 and may be of interest to user 110. In some instances, system 140 may also obtain information identifying a performance of the stock fund held by user 110 and/or the common stock issued by Nissan Motor Co. Ltd.™ and/or Tesla Motors™ during a current or previous trading session.

In certain aspects, system 140 may transmit information identifying both the suggested security (e.g., common stock in Tesla Motors™) and relevant portions of user 110's actual or virtual investment portfolio (e.g., the stock fund and/or common stock issued by Nissan Motor Co. Ltd.™) for presentation to user 110, via client device 104. FIG. 7B illustrates an exemplary interface that may be provided by client device 104 consistent with disclosed embodiments.

For example, client device 104 may receive, render, and present the information within a pop-up or other interface 710 that obscures at least a portion of additional content presented in an interface for display to user 110. for example, interface 710 may also include information 712 that identifies one or more securities that are currently held by user 110 (e.g., positions in a stock fund that includes common stock issued by Nissan Motor Co. Ltd.™) and further, that are relevant to a current social media activity of user 110. For example, information 712 may alert user 110 to the presence of common stock issued by Nissan Motor Co. Ltd.™ within an actual investment portfolio, and may further provide information identifying a performance of the common stock and/or the corresponding mutual fund during a current or prior trading session.

Further, interface 710 may also include information 714 that identifies a security (e.g., the common stock in Tesla Motors™) of potential interest to user 110 and consistent with user 110's investment risk tolerance, and additionally or alternatively, a performance of that security during a current or prior trading session. By way of example, information 714 may recommend that user 110 purchase common stock in Tesla Motors™ based on user 110's interest in electric vehicles, such as the “liked” Nissan Leaf™ and user 110's acceptance of investment portfolio risk. The information provided in interface 710 may be determined and provided by system 140 in accordance with one or more processes disclosed above.

In FIG. 7B, interface 710 may also include a region 616 that, upon selection by user 110, may enable user 110 to access a digital portal associated with system 140. As described above, the digital portal may enable user 110 to generate or modify an actual or “virtual” investment portfolio, and additionally or alternatively, a “watch list,” composed of simulated positions in one or more of the suggested securities. In some aspects, user 110 may click within, press, or otherwise select region 716 to gain access to the digital portal, which client device 104 may, for example, render and present to user 110 within a separate window or interface element. Furthermore, as described above, interface 610 may also include an additional region 718 that, upon selection by user 110, causes client device 104 to close, remove from view, and/or minimize interface element 710, and continue to view social media content 700 unobscured.

In certain embodiments, system 140 may generate commands to execute a purchase and/or sale of securities to rebalance an existing investment portfolio of the user (e.g., in step 312 in accordance with the response received step 310), and additionally or alternatively, to execute a purchase of securities to generate an investment portfolio for the user (e.g., in step 330 in accordance with the response received in step 328). In some aspects, system 140 may identify one or more incentives available to the user based on the executed purchases and/or sales of the securities (e.g., retail coupons for goods or services provided, manufactured, transported, etc. by issuers of the securities or related entities). For example, based on a purchase of Comcast™ stock, system 140 may generate a retail coupon including a discount on the monthly access to content provided by Comcast™ (e.g., a reduced monthly rate to access a channel presenting newly released movies), and may provide information identifying the retail coupon within the generated confirmation in step 314 and/or in step 332.

In other aspects, system 140 may identify a rewards and/or loyalty program provided by an issuer of one or more of the securities purchased (or sold) to effect the portfolio rebalancing and/or creation. For example, system 140 may determine that the user does not participate in the identified rewards or loyalty program, and may provide information that enables user 110's registration in the identified rewards or loyalty program within the generated confirmation in steps 314 and/or 332. Further, a business relationship may exist between the financial institution and the issuer (i.e., the provider of the identified rewards or loyalty program), or the financial institution may provide the identified rewards or loyalty program. In some aspects, system 140 may, for example, enroll user 110 in a temporary or “trial” membership in the identified rewards or loyalty program, and may communicate details of the temporary membership to the user within the confirmation generated in steps 314 and/or 332.

Further, in additional aspects, system 140 may determine that the user is a member of the identified rewards or loyalty program. System 140 may, in some instances, provide information identifying the equity purchase to the provider of the identified rewards or loyalty program, which may add loyalty or rewards points to user 110's account. For example, system 140 may generate instructions that execute a purchase securities issued by Marriott International, Inc., to rebalance user 110's investment portfolio, and in response to the purchase, Marriott International, Inc., may add loyalty points to the user's Marriott™ rewards account and/or provide amenities accessible by the user (e.g., an upgrade) in response to the purchase. In some aspects, system 140 may perform processes that increase the point balance by a value determined in accordance with one or more rules established by the loyalty or reward program (e.g., Marriott International, Inc.). Returning to FIG. 3, system 140 may provide information identifying the accrued points and/or amenities to the user within the confirmation generated in steps 314 and/or 332.

In some aspects, system 140 may also provide the user with a rebate or discount on a purchase securities effecting a portfolio rebalancing process (e.g., in step 312 in accordance with the response received in step 310) or a portfolio generation process (e.g., in step 330 in accordance with the response received in step 328). For example, based on user 110's consumption of electronic content (or social networking activity) related to Comcast™, system 140 may waive a trading fee associated with the purchase of the securities issued by Comcast™, and/or provide a discount or rebate on the purchase of these securities. As a further incentive to incorporate securities issued by Comcast™ in user 110's investment portfolio, system 140 may extend to user 110 an additional rebate on additional purchase of these securities during a predetermined further period of time (e.g., thirty days).

In other instances, system 140 may determine that user 110 is a member of a Marriott™ rewards program provided by Marriott International, Inc., and that a portfolio rebalancing strategy includes the purchase of securities issued by Marriott International, Inc. In an embodiment, and based on the user's membership in the Marriott™ rewards program, server 140 may waive a trading fee associated with the purchase of the securities issued by Marriott International, Inc., and/or provide a discount or rebate on the purchase of the securities. Further, as an incentive to purchase additional shares of Marriott International, Inc., server 140 may extend to the user an additional rebate on future purchase of these securities.

Additionally, in the exemplary embodiments described above, system 140 may also generate and/or update watchlists to include information identifying one or more of the suggested securities. For example, system 140 may add information identifying common stocks issued by Comcast™ to the user 110's watchlist. In response to the addition of the Comcast™ stock to the watchlist, transaction server 142 may generate a retail coupon including a discount on the monthly access to content provided by Comcast™, and may provide information identifying the retail coupon with information updating the user on the addition to the watchlist.

Further, in certain aspects, the issuance of retail coupons may be linked to a frequency at which user 110 updates an existing watchlist, rebalances an existing virtual investment portfolio, or creates a new watchlist or virtual investment portfolio. For example, system 140 may be configured to issue retail coupons and other incentives to user 110 for a threshold number of watchlist and virtual investment portfolio creation and/or update events within a predetermine time period (e.g., five watchlist updates per month). By limiting the number of issued incentives, system 140 may in some instances limit an ability of user 110 to “game the system” and improperly modify or create watchlists or virtual investment portfolios to obtain desired incentives and retail coupons.

In other aspects, as an incentive to purchase one or more of the securities on user 110's watchlist (e.g., the incorporate the watchlisted security to the actual investment of the user), server 140 may provide the user with a discount or rebate on a trading fee associated with the purchase. For example, as an incentive to user 110, system 140 may enable the user to purchase securities issued by Comcast™, which may be listed on user 110's watchlist, without a corresponding trading fee imposed by the financial institution, and additionally or alternatively, at a specified discount to an exchange price.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A system, comprising:
a storage device; and
at least one processor coupled to the storage device, the storage device storing software instructions for controlling the at least one processor when executed by the at least one processor, and the at least one processor being operative with the software instructions and configured to:
determine an investment risk tolerance of a user;
obtain program data identifying a first loyalty program associated with the user, the user being a participant in the first loyalty program;
obtain digital activity data associated with the user, the digital activity data including at least one of (i) first data indicative of an interaction between the user and a social network or (ii) second data indicative of elements of electronic content accessed by the user;
identify a plurality of first securities based on the digital activity data, the first loyalty program, and the investment risk tolerance; and
generate an electronic command to transmit information identifying a first set of the first securities to a device of the user.

2. The system of claim 1, wherein the at least one processor is further configured to transmit, to the first user device, information identifying an incentive to purchase the first set of the first securities, the incentive comprising at least one of a waiver of a purchase transaction fee or a reduction in a share price.

3. The system of claim 1, wherein the at least one processor is further configured to perform processes that purchase the first set of the first securities to create or modify an investment portfolio of the user.

4. The system of claim 3, wherein the at least one processor is further configured to:
identify a point balance associated with the first loyalty program; and
perform processes that increase the point balance by a value determined in accordance with a rule established by the first loyalty program.

5. The system of claim 3, wherein the at least one processor is further configured to:
identify, in response to the purchase of the first securities, a second loyalty program available to the first user, the second loyalty program being associated with an issuer of at least one of the first set of the first securities; and
generate a second electronic command to transmit information identifying the second loyalty program to the first user device.

6. The system of claim 3, wherein the at least one processor is further configured to:
in response to the purchase of the first securities, generate information identifying an incentive to purchase a product or service associated with an issuer of at least one of the first set of the first securities; and
generate a second electronic command to transmit the generated purchase incentive information to the first user device.

7. The system of claim 6, wherein the purchase incentive comprises a coupon.

8. The system of claim 3, wherein the at least one processor is further configured to:
determine whether the investment portfolio conforms to an investment goal of the user; and
perform operations that sell at least one of the purchased first securities, when the investment portfolio fails to conform to the investment goal,
the investment goal comprising at least one of a cash reserve, a ratio of debt securities to equity securities, or a limit on a value of the investment portfolio.

9. The system of claim 1, wherein the at least one processor is further configured to generate or modify at least one of a virtual investment portfolio or a watchlist for the first user, the at least one virtual investment portfolio or watchlist comprising a first simulated financial position in at least one of the first securities.

10. The system of claim 9, wherein the at least one processor is further configured to:
generate an incentive to purchase a product or service associated with an issuer of the at least one of the one or more first securities; and
generate a second electronic command to transmit the generated purchase incentive to the first user device.

11. The system of claim 10, wherein the purchase incentive comprises a coupon redeemable at a retailer.

12. The system of claim 10, wherein the at least one processor is further configured to:
identify a number of prior purchase incentives provided to the user device in a predetermined time period;
determine whether the identified number exceeds a threshold number; and
when the identified number is determined not to exceed the threshold value, generate the second electronic command to transmit the purchase incentive to the user device.

13. The system of claim 1, wherein the at least one processor is further configured to:
identify a first position in at least one of the first set of the first securities, the first position corresponding to an investment strategy for incorporating the first set of the first securities into at least one investment portfolio or watchlist; and
generate a second electronic command to transmit information identifying the first position to the user device.

14. The system of claim 13, wherein the at least one processor is further configured to:
identify a second position in at least one of the first set of the one or more first securities; and
generate the second electronic command to transmit information identifying the first and second positions to the first user device.

15. The system of claim 1, wherein the at least one processor is further configured to:
identify at least one of an investment program or an investment offering related to (i) the first loyalty program and (ii) at least one of the first or second data; and
generate a second electronic command to transmit information identifying the at least one investment program or offering to the user device.

16. The system of claim 15, wherein:
the investment offering comprises an initial public offering of at least one second security; and
the investment program comprises a dividend reinvestment program.

17. The system of claim 1, wherein the at least one processor is further configured to:
based on the digital activity data, determine geographic data associated with the user, the geographic data specifying a geographic region associated with at least one the first or second data; and
identify the first securities based on the geographic data, the first securities being related to the first loyalty program, the at least one of the first or second data, and the geographic region.

18. The system of claim 17, wherein the first securities comprise at least one of a debt security issued by a governmental entity associated with the geographic region or an equity security issued by a corporate entity having a relationship with the geographic region.

19. The system of claim 1, wherein the at least one processor is further configured to:
at least one of (i) receive the investment risk tolerance from the user device, or (ii) determine the investment risk tolerance based on an outcome of a digital financial investing activity.
determine a modified investment risk tolerance in accordance with at least one of a prior financial services transaction or a composition of an investment portfolio of the user; and
identify the one or more first securities based on the digital activity data and the modified investment risk tolerance.

20. The system of claim 1, wherein the at least one processor is further configured to:
identify a candidate security associated with a corresponding issuer, the candidate security being available to the user;
determine whether a first relationship exists between the corresponding issuer and a portion of at least one of the first data or the second data, and
when the first relationship exists, establish the identified candidate as one of the first securities, based on the determined first relationship.

21. The system of claim 20, wherein:
the at least one processor is further configured to:
determine whether a second relationship exists between the corresponding issuer and the at least one product, service, or business entity, based on the first data, and
when the second relationship exists, establish the identified candidate as one of the first securities; and
the first data identifies at least one of:
the at least one product, service, or business entity;
a direct connection between the user and the at least one product, service, or business entity within the social network;
an indirect connection between the user and the at least one product, service, or business entity within the social network, the indirect connection occurring through at least one intermediate user; or
a subscription by the user to a social media news feed associated with the at least one product, service, or business entity.

22. The system of claim 20, wherein:
the obtained electronic content elements comprises at least one of a web page, an element of audio content, an element of video content, or an application executable by the user device;
the second data identifies at least one of a product, a service, a business entity associated with the user, or a business entity associated with the electronic content; and
the at least one processor is further configured to:
determine whether a second relationship exists between the corresponding issuer and the at least one product, service, or business entity, based on the second data; and
when the second relationship exists, establish the identified candidate as one of the first securities.

23. The system of claim 22, wherein the second data identifies a web page accessed by the user, the at least one product, service, or business entity being associated with at least a portion of the web page.

24. The system of claim 22, wherein:
the second data identifies a news feed to which the user subscribes; and
the at least one product, service, or business entity is associated with at least one of a provider of the news feed or content associated with the news feed.

25. The system of 22, wherein the second data identifies a purchase of product or service through a web page associated with the business entity.

26. The system of claim 22, wherein the second data identifies an application program executable by the user device.

27. A computer-implemented method, comprising:
obtaining, by one or more processors, an investment risk tolerance of a user;
obtaining, by the one or more processors, program data identifying a first loyalty program associated with the user, the user being a participant in the first loyalty program;
obtaining, by the one or more processors, digital activity data associated with the user, the digital activity data including at least one of (i) first data indicative of an interaction between the user and a social network or (ii) second data indicative of elements of electronic content accessed by the user;
identifying, by the one or more processors, a plurality of first securities based on the digital activity data, the first loyalty program, and the investment risk tolerance; and
generating, by the one or more processors, an electronic command to transmit information identifying a first set of the first securities to a device of the user.

28. A system, comprising:
a storage device; and
at least one processor coupled to the storage device, the storage device storing software instructions for controlling the at least one processor when executed by the at least one processor, and the at least one processor being operative with the software instructions and configured to:
determine an investment risk tolerance of a user;
obtain digital activity data associated with the user, the digital activity data including at least one of (i) first data indicative of an interaction between the user and a social network or (ii) second data indicative of elements of electronic content accessed by the user;
based on the digital activity data, determine geographic data associated with the user, the geographic data specifying a geographic region associated with at least one the first or second data; and
identify a plurality of first securities based on the digital activity data, the geographic data, and the investment risk tolerance; and
generate an electronic command to transmit information identifying a first set of the first securities to a device of the user.

29. The system of claim 28, wherein the first securities comprise at least one of a debt security issued by a governmental entity associated with the geographic region or an equity security issued by a corporate entity having a relationship with the geographic region.

30. The system of claim 28, wherein the at least one processor is further configured to:
obtain program data identifying a first loyalty program associated with the user, the user being a participant in the first loyalty program;
identify the first securities based on the program data, the first securities being related to the first loyalty program, the at least one of the first or second data, and the geographic region.
